(19) United States
(12) Patent Application Publication
(10) Pub. No.: US 2010/0209665 A1
(43) Pub. Date: Aug. 19, 2010

(54) ULTRA SMOOTH NANOSTRUCTURED DIAMOND FILMS AND COMPOSITIONS AND METHODS FOR PRODUCING SAME

(76) Inventors: Valeriy V. Konovalov, Westerville, OH (US); Yogesh K. Vohra, Hoover, AL (US); Shane A. Catledge, Bessemer, AL (US)

Correspondence Address: Ballard Spahr LLP, SUITE 1000, 999 PEACHTREE STREET, ATLANTA, GA, 30309-3915, US

(21) Appl. No.: 12/088,072

(22) PCT Filed: Sep. 29, 2006
(86) PCT No.: PCT/US06/38222

§ 371 Date: Jun. 26, 2009

Related U.S. Application Data
(60) Provisional application No. 60/721,697, filed on Sep. 29, 2005.

(51) Int. Cl. B32B 3/26; H05H 1/24; C09D 5/00; C09D 1/00

(52) U.S. Cl. 428/141; 427/569; 106/287.26; 106/285; 106/286.8; 106/287.3; 977/734; 977/742

(57) ABSTRACT

Disclosed are compositions and methods for producing carbon-based films, for example, ultra smooth diamond nanostructured diamond films. Generally, the disclosed compositions can comprise a noble gas component, hydrogen, a carbon precursor, and nitrogen. Generally, the disclosed methods can comprise the steps of providing a mixture comprising a noble gas, hydrogen, a carbon precursor, and nitrogen, establishing a plasma comprising the mixture; and depositing carbon-containing species from the plasma onto the surface, thereby producing a film on the surface. Generally, the disclosed films exhibit superior average gain size, RMS surface roughness, hardness, relative diamond crystallinity, and surface adhesion. This abstract is intended as a scanning tool for purposes of searching in the particular art and is not intended to be limiting of the present invention.

### CROSS REFERENCE TO RELATED APPLICATIONS

This application claims the benefit of U.S. Application No. 60/721,697 filed Sep. 29, 2005, which is hereby incorporated herein by reference in its entirety.

### ACKNOWLEDGEMENT

This invention was made with government support under Grant R01 DE013952 awarded by the National Institute of Dental and Craniofacial Research. The U.S. government has certain rights in the invention.

### BACKGROUND

Polycrystalline diamond films with a microstructure consisting generally of crystallites with sizes on the order of microns can be synthesized by a variety of chemical vapor deposition (CVD) techniques from carbon-hydrogen mixtures, typically using hydrocarbons as the carbon source. The grain size, surface morphology, and surface roughness of the polycrystalline diamond films prepared from hydrogen-rich plasmas typically depend upon the film thickness. Generally, for conventional methods of preparation, the thicker the film, the larger the grain size and the rougher the surface of the film.

Many applications of diamond films, however, demand ultra smooth surfaces, which are not prepared by conventional techniques. Consequently, such diamond films generally fail to achieve satisfactory average grain size or satisfactory surface smoothness. Additionally, the relative diamond crystallinity of such materials is generally too high, thereby resulting in brittle films that fail to achieve satisfactory surface adhesion.

In contrast, amorphous carbon films, also called diamond-like carbon (DLC) films, are generally highly amorphous, sp²- and sp³-based carbon materials. DLC films include amorphous carbon (a-C) films and tetrahedral carbon (t-C) films. t-C films typically have higher content of sp³ carbon versus sp² carbon and are typically harder than a-C, with a hardness of up to about 40-60 GPa. Diamond-like carbon films do not contain diamond crystallites and are, therefore, distinct from diamond layers, which are typically fabricated by using plasma-based or hot-filament deposition. DLC films are known to have high residual stress (up to 10 GPa), which can result in poor adhesion on steels, carbides, and other materials, and also prevents the growth of thick films. Thus, the applications of DLC films are limited. Modification of DLC films with trace elements can improve adhesion, but this typically limits the hardness of DLC films to an unsatisfactory 10-20 GPa. Consequently, with DLC films, it can be possible to have smooth film surfaces, but DLC films do not exhibit desired adhesion, stability, or hardness.

Therefore, there remains a need for methods and compositions that overcome these deficiencies and that effectively provide films having small average grain size, improved surface smoothness, satisfactory surface adhesion, and/or desirable stability and hardness.

### SUMMARY

Disclosed herein are methods of producing ultra smooth nanostructured diamond films on a surface. In particular, disclosed are methods of producing an ultra smooth nanostructured diamond film on a surface comprising the steps of providing a mixture comprising a noble gas, hydrogen, a carbon precursor, and nitrogen, wherein the noble gas and the nitrogen are present in combined concentration of less than about 80 vol % of the mixture; establishing a plasma comprising the mixture; and depositing carbon-containing species from the plasma onto the surface, thereby producing a film on the surface. Also disclosed are methods of producing an ultra smooth diamond film on a surface comprising the steps of providing a mixture comprising a noble gas, hydrogen, a carbon precursor, and nitrogen, wherein the carbon precursor is present in a concentration of at least about 4 vol % of the mixture; establishing a plasma comprising the mixture; and depositing the plasma on a surface, thereby producing a film on the surface. Also disclosed are methods of producing an ultra smooth nanostructured diamond film on a surface comprising the steps of providing a mixture comprising a noble gas, hydrogen, a carbon precursor, and nitrogen, wherein the carbon precursor is present in a concentration of at least about 10 vol % of the mixture, and wherein the noble gas and the nitrogen are present in combined concentration of less than about 75 vol % of the mixture; establishing a plasma comprising the mixture; and depositing carbon-containing species from the plasma onto the surface, wherein the surface comprises Ti-6Al-4V, thereby producing a film on the surface. Also disclosed are the products produced by these methods.

Further disclosed herein are compositions comprising a noble gas component, hydrogen, a carbon precursor in a concentration of at least about 5 vol % of the composition, and nitrogen. Also disclosed are compositions comprising a noble gas component, hydrogen, a carbon precursor, and nitrogen, wherein the noble gas component and the nitrogen are present in a combined concentration of less than about 80 vol % of the composition. Also disclosed are compositions comprising a noble gas component in a concentration of from about 25 vol % to about 93.9 vol %, hydrogen in a concentration of from about 3 vol % to about 40 vol %, a carbon precursor in a concentration of from about 3 vol % to about 15 vol %, and nitrogen in a concentration of from about 0.1 vol % to about 20 vol %. Also disclosed are compositions comprising a noble gas component, hydrogen, a carbon precursor, and nitrogen, wherein the composition comprises a plasma, wherein the carbon precursor is present in a concentration of at least about 10 vol % of the composition, wherein the noble gas component and the nitrogen are present in a combined concentration of less than about 75 vol % of the composition, wherein the noble gas component comprises helium, and wherein the carbon precursor comprises methane.

Further disclosed herein are ultra smooth nanostructured diamond films having an average grain size of from about 3 nm to about 9 nm and an RMS surface roughness of from about 5 nm to about 14 nm. Also disclosed are ultra smooth nanostructured diamond films having an average grain size of from about 3 nm to about 9 nm and a relative diamond crystallinity of up to about 70%. Also disclosed are ultra smooth diamond films having an average grain size of from about 5 nm to about 6 nm, an RMS surface roughness of from about 5 nm to about 10 nm before mechanical polishing of the film, a relative diamond crystallinity of from about 40% to about 60%, and a hardness of from about 50 GPa to about 100 GPa. Also disclosed are ultra smooth diamond films having an average grain size of from about 5 nm to about 6 nm, an RMS surface roughness of from about 5 nm to about 10 nm before mechanical polishing of the film, a relative diamond crystallinity of from about 40% to about 60%, and a hardness of from about 58 GPa to about 72 GPa.

Further disclosed herein are carbon-based films having an RMS surface roughness of less than about 14 nm and a hardness of at least about 50 GPa.

### BRIEF DESCRIPTION OF THE FIGURES

The accompanying drawings, which are incorporated in and constitute a part of this specification, illustrate several embodiments and together with the description illustrate the disclosed compositions and methods.

FIG. 1 shows 1×1 μm AFM surface images and XRD 20-angular dependencies of two diamond films grown in He/H₂/CH₄/N₂ plasma with (a) 0 and (b) 71 vol % He.

FIG. 2 shows diamond films grown in He/H₂/CH₄/N₂ plasma at different He contents: (a) FWHM of the (111) diamond XRD peak and calculated average diamond grain size. (b) RMS surface roughness (RMSR) of the films calculated from 2×2 μm AFM images.

FIG. 3 shows Micro-Raman spectra (2=514.5 nm) for diamond films grown from He/H₂/CH₄/N₂ plasma with different He contents. Background lines were subtracted for better peak presentation.

FIG. 4 shows (a) Growth rate of diamond films versus He content in He/H₂/CH₄/N₂ plasma. (b) Normalized optical emission intensities of Balmer H_{β} (1, 486.14 nm), C₂ (2, 516.5 nm), and CN (3, 386 nm) lines versus He content in He/H₂/CH₄/N₂ plasma. Lines were normalized to Balmer H_{α} line (656.3 nm) intensity.

FIG. 5 shows a schematic of Microwave Plasma Chemical Vapor Deposition (MPCVD) reactor.

FIG. 6 shows diamond films grown in He/H₂/CH₄ plasma at different He contents and no N₂ (a) FWHM of the (111) diamond XRD peak and calculated average diamond grain size. (b) RMS surface roughness (RMSR) of the films calculated from 2×2 μm AFM images.

FIG. 7 shows growth rate of diamond films at different N₂/CH₄ volume ratio in He/H₂/CH₄/N₂ plasma. In the insert optical interference pattern collected from interferometer is shown for film deposited at N₂/CH₄=0.4.

FIG. 8 shows the optical emission spectra of the He/H₂/CH₄/N₂ microwave plasmas with different ratio of N₂/CH₄. (a) N₂/CH₄=0.05 and (b) N₂/CH₄=0.4. It is to be noted that the intensity scale in the two spectra are different, CN peak increase in intensity by a factor of ten.

FIG. 9 shows normialized optical emission intensities of Balmer H_{β} (1, 486.14 nm), C₂ (2, 516.5 nm), and CN (3, 386 nm) lines versus N₂/CH₄ content in He/H₂/CH₄/N₂ plasma. Lines were normalized to Balmer H_{α} line (656.3 nm) intensity.

FIG. 10 shows the XRD patterns of the He/H₂/CH₄/N₂ microwave plasmas with different ratio of N₂/CH₄. The insert shows the close-up view of TiC and diamond (111) peaks showing the change due to the change of N₂/CH₄ volume ratio.

FIG. 11 shows FWHM of the diamond (111) XRD peak and calculated average diamond grain size of diamond films grown in He/H₂/CH₄/N₂ plasma at different N₂/CH₄ flow ratio.

FIG. 12 shows a SEM image at 300,000× of the diamond film surface grown in He/H₂/CH₄/N₂ plasma at N₂/CH₄ flow ratio of 0.4.

FIG. 13 shows Micro-Raman spectra for high density plasma processed nanostructured diamond films on Ti-6Al-4V alloy at different N₂/CH₄ feed gas fraction. The spectra were normalized from the as received one shown in the insert.

FIG. 14 shows the plan view AFM images of the as-grown diamond films prepared from microwave plasma showing the morphological change due to change in different deposition conditions (a) CH₄/H₂ plasma without N₂ (b) CH₄/H₂ plasma with N₂ (c-h) He/H₂/CH₄/N₂ plasma with different N₂/CH₄ ratios (c) N₂/CH₄: 0.05 (d) 0.1 (e) 0.2 (f) 0.3 (g) 0.4. (h) 0.5.

FIG. 15 shows a plot of the surface roughness measured in 2×2 μm area of different as-grown diamond films with different N₂/CH₄ ratios in He/H₂/CH₄/N₂ plasma. Roughness values are also given for uncoated polished Ti-6Al-4V substrates.

FIG. 16 shows nanoindentation hardness versus depth for high density plasma processed ultra smooth nanostructured diamond coating at N₂/CH₄ ratio 0.3 in He/H₂/CH₄/N₂ plasma. Nanoindentation load-displacement curve for same sample is shown in the insert.

### DETAILED DESCRIPTION

Before the present compounds, compositions, articles, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular embodiments only and is not intended to be limiting.

### A. DEFINITIONS

As used in the specification and the appended claims, the singular forms “a,” “an” and “the” include plural referents unless the context clearly dictates otherwise. Thus, for example, reference to “a component,” “a surface,” or “a noble gas” includes mixtures of two or more such components, surfaces, or noble gases, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

“Volume percent” or “vol %” means the percentage of the total volume of a composition or mixture due to a particular component. As used herein, the volume percent of a particular component is used with respect to the total volume of a noble gas component, hydrogen, a carbon precursor, and nitrogen. For the disclosed compositions and methods, it is understood that each component can be present in the disclosed compositions, along with the other three components, in a concentration necessary for the total concentration of a noble gas component, hydrogen, a carbon precursor, and nitrogen to equal 100 vol %.

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

It is understood that the compositions disclosed herein have certain functions. Disclosed herein are certain structural requirements for performing the disclosed functions, and it is understood that there are a variety of structures which can perform the same function which are related to the disclosed structures, and that these structures will typically achieve the same result.

### B. CHEMICAL VAPOR DEPOSITION OF DIAMOND FILMS

Chemical vapor deposited (CVD) diamond films grown using gas mixtures such as hydrogen, nitrogen, and methane have been investigated primarily in order to get smooth nanocrystalline diamond film. [S. A. Catledge and Y. K. Vohra, J. Appl. Phys. 84, 6469 (1998); S. A. Catledge, J. Borham, Y. K. Vohra, W. R. Lacefield, and J. E. Lemons, J. Appl. Phys. 91, 5347 (2002); A. Afzal, C. A. Rego, W. Ahmed, and R. I. Cherry, Diam. Rel. Mater. 7, 1033 (1998); R. B. Corvin, J. G. Harrison, S. A. Catledge, and Y. K. Vohra, Appl. Phys. Lett. 84, 2550 (2002).] A surface roughness value of 15-20 nm (RMS) and a grain size of 13-15 nm have been achieved. A film grown without nitrogen addition typically shows large, well defined crystalline facets indicative of high-phase-purity diamond. [S. A. Catledge and Y. K. Vohra, J. Appl. Phys. 83, 198 (1998).] In contrast, films grown with added nitrogen typically exhibit a nanocrystalline appearance with weak agglomeration into rounded nodules of submicron size. It has also been observed that the transformation from microcrystalline to nanocrystalline diamond structure can occur by adding Ar in H₂/CH₄ feed gases with a total transformation observed at Ar/H₂ volume ratio of 9. [D. Zhou, D. M. Gruen, L. C. Qin, T. G. McCauley, and A. R. Krauss, J. Appl. Phys. 84, 1981 (1998); D. M. Gruen, Annu. Rev. Mater. Sci. 29, 211 (1999).] Surface roughness as low as 18 nm and grain size of 3-50 nm was demonstrated on highly polished (area RMS˜1 nm) silicon (111) wafers. [D. Zhou, D. M. Gruen, L. C. Qin, T. G. McCauley, and A. R. Krauss, J. Appl. Phys. 84, 1981 (1998).] The effect of helium addition to H₂/CH₄/N₂ feedgas mixtures on growth of high quality ultra-smooth nanostructured diamond films on Ti-6Al-4V has been reported. [V. V. Konovalov, A. Melo, S. A Catledge, S. Chowdhury, Y. K. Vohra, J. Nanosci. and Nanotechnol., 6, 258 (2006).] In one aspect, the addition of He reduced film roughness to 9-10 nm and grain size of diamond nanocrystals to 5-6 nm without deterioration of film hardness, or adhesive properties. [V. V. Konovalov, A. Melo, S. A Catledge, S. Chowdhury, Y. K. Vohra, J. Nanosci. and Nanotechnol., 6, 258 (2006).]

### C. COMPOSITIONS FOR PRODUCING ULTRA SMOOTH FILMS

Various compositions can be used to perform the disclosed methods and used to prepare the disclosed films. In one aspect, the compositions can comprise a feedgas mixture. In a further aspect, the compositions can comprise a plasma.

For example, in one aspect, the disclosed compositions can comprise a noble gas component, hydrogen, a carbon precursor in a concentration of at least about 4 vol % of the composition, and nitrogen. In a further aspect, the compositions can comprise a noble gas component, hydrogen, a carbon precursor, and nitrogen, wherein the noble gas component and the nitrogen are present in a combined concentration of less than about 80 vol % of the composition.

In a yet further aspect, the compositions can comprise a noble gas component in a concentration of from about 25 vol % to about 93.9 vol %, hydrogen in a concentration of from about 3 vol % to about 40 vol %, a carbon precursor in a concentration of from about 3 vol % to about 15 vol %, and nitrogen in a concentration of from about 0.1 vol % to about 20 vol %.

In a still further aspect, the compositions can comprise a noble gas component, hydrogen, a carbon precursor, and nitrogen, wherein the composition comprises a plasma, wherein the carbon precursor is present in a concentration of at least about 10 vol % of the composition, wherein the noble gas component and the nitrogen are present in a combined concentration of less than about 75 vol % of the composition, wherein the noble gas component comprises helium, and wherein the carbon precursor comprises methane.

Various components can be used in the disclosed compositions. In one aspect, the disclosed compositions can comprise at least for components. For example, in one aspect, the disclosed compositions can comprise a noble gas component, hydrogen, a carbon precursor, and nitrogen.

1. Noble Gas Component

Various noble gasses can be used in the disclosed compositions to perform the disclosed methods to prepare the disclosed films. In one aspect, the noble gas component can comprise helium, neon, argon, krypton, xenon, radon, or a mixture thereof. In a further aspect, the noble gas component can be helium. As used herein, by “a noble gas,” it is meant at least one noble gas.

In one aspect, the noble gas component is present in the disclosed compositions in a concentration of from about 40 vol % to about 95 vol %. For example, the noble gas component can be present at from about 40 vol % to about 90 vol %, from about 50 vol % to about 80 vol %, from about 60 vol % to about 70 vol %, from about 50 vol % to about 60 vol %, from about 60 vol % to about 70 vol %, from about 70 vol % to about 80 vol %, from about 80 vol % to about 90 vol %, from about 60 vol % to about 80 vol %, or from about 70 vol % to about 80 vol %. In a further aspect, the noble gas component is present at from about 25 vol % to about 93.9 vol %.

In a further aspect, the noble gas component and nitrogen can be present in the disclosed compositions in a combined concentration of less than about 80 vol % of the composition. In a yet further aspect, the noble gas component and the nitrogen can be present in a combined concentration of less than about 75 vol % of the composition. For example, the noble gas component and nitrogen, can be present at from about 40 vol % to about 80 vol %, from about 40 vol % to about 75 vol %, from about 45 vol % to about 75 vol %, from about 50 vol % to about 70 vol %, from about 55 vol % to about 65 vol %, from about 60 vol % to about 70 vol %, from about 65 vol % to about 75 vol %, from about 70 vol % to about 75 vol %, from about 75 vol % to about 80 vol %, from about 65 vol % to about 75 vol %, or from about 70 vol % to about 80 vol %.

In a yet further aspect, mixtures of two or more noble gasses can be used in the disclosed compositions to perform the disclosed methods and/or to prepare the disclosed films. For example, the noble gas component can be present as a mixture of from about 1 vol % to about 99 vol % helium and from about 99 vol % to about 1 vol % argon, for example, as a mixture of from about 10 vol % to about 90 vol % helium and from about 90 vol % to about 10 vol % argon, from about 20 vol % to about 80 vol % helium and from about 80 vol % to about 20 vol % argon, from about 30 vol % to about 70 vol % helium and from about 70 vol % to about 30 vol % argon, from about 40 vol % to about 60 vol % helium and from about 60 vol % to about 40 vol % argon, or as about 50 vol % He and about 50 vol % Ar. It is understood that other noble gasses (for example, neon, krypton, xenon, and/or radon) can be added to or substituted for helium and/or argon in the disclosed mixtures, compositions, and methods.

2. Hydrogen

In one aspect, the disclosed compositions comprise hydrogen. Generally, hydrogen can be present in a concentration of from about 3 vol % to about 40 vol %. For example, hydrogen can be present in a concentration of from about 5 vol % to about 35 vol %, from about 10 vol % to about 30 vol %, from about 15 vol % to about 25 vol %, from about 3 vol % to about 10 vol %, from about 5 vol % to about 10 vol %, from about 5 vol % to about 15 vol %, from about 10 vol % to about 15 vol %, from about 10 vol % to about 20 vol %, or from about 15 vol % to about 20 vol %.

In a further aspect, hydrogen can be present in the disclosed compositions in a concentration greater than the concentration of carbon precursor. For example, hydrogen can be present in a concentration of about twice, about three times, or about four times the concentration of the carbon precursor.

3. Carbon Precursor

Various carbon precursors can be used in the disclosed compositions to perform the disclosed methods to prepare the disclosed films. Generally, the carbon precursor can be a carbon-containing compound or mixture that is a gas or that can be volatized in the disclosed compositions.

In one aspect, the carbon precursor comprises methane, a C₂ to C₁₂ alkane, ethene, a C₃ to C₁₂ alkene, acetylene, a C₃ to C₁₂ alkyne, benzene, toluene, xylene, a C₁ to C₁₂ alcohol, graphitic particles, a carbon cluster of at least C₂, a diamondoid, buckminsterfullerene, a higher fullerene, a carbon nanotube, a carbon nanoparticle, or a mixture thereof. In yet another aspect, the carbon precursor can comprise methane.

Generally, in one aspect, the carbon precursor can be an aliphatic or aromatic hydrocarbon, and can be either substituted or unsubstituted. In a further aspect, the carbon precursor can be an alkane. In particular, for example, the carbon precursor can be methane, ethane, propane, butane, isobutene, pentane, isopentane, test-pentane, an isomer of hexane, or a higher alkane. As another example, the carbon precursor can be an alkene. In particular, the carbon precursor can be ethene, propene, an isomer of butene, 1,3-butadiene, an isomer of pentene or pentadiene, or an isomer of hexene, an isomer of hexadiene, hexatriene, or a higher alkene. As a further example, the carbon precursor can be an alkyne. In particular, the carbon precursor can be acetylene, propyne, an isomer of butyne, an isomer of pentyne, penta-1,4-diyne, or an isomer of hexyne, an isomer of hexadiyne, or a higher alkyne. It is also contemplated that higher molecular weight hydrocarbons can be used in the disclosed compositions and methods.

In a further aspect, the carbon precursor can be an aromatic compound. In particular, for example, the carbon precursor can be benzene, toluene, or xylene. It is also contemplated that higher molecular weight aromatic compounds can be used in the disclosed compositions and methods.

Generally, in a further aspect, the carbon precursor can be an aliphatic or aromatic alcohol, and can be either substituted or unsubstituted. In particular, the carbon precursor can be methanol, ethanol, n-propanol, isopropanol, an isomer of butanol, an isomer of pentanol, an isomer of hexanoyl, or a higher alcohol. In a further aspect, the carbon precursor can be a diol or triol. For example, the carbon precursor can be ethylene glycol, propane-1,3-diol, butane-1,2-diol, butane-1,3-diol, butane-1,4-diol, an isomer of pentanediol, an isomer of hexanediol, pentaerythritol, or a higher diol or triol. It is also contemplated that higher molecular weight alcohols can be used in the disclosed compositions and methods.

Generally, in a further aspect, the carbon precursor can be a carbon cluster of at least C₂. In a further aspect, the carbon precursor can be a fullerene, for example, graphitic particles, buckminsterfullerene (C₆₀) or a higher fullerene, such as C₇₀ or C₈₄. In another aspect, the carbon precursor can be a carbon nanotube or a carbon nanoparticle. In another aspect, the carbon precursor can be a diamondoid. As used herein, a diamondoid is an adamantine based structure, other than diamond. It is also contemplated that higher molecular weight carbon-containing compounds and materials can be used in the disclosed compositions and methods.

Generally, the carbon precursor is present in a concentration of from about 3 vol % to about 15 vol %. For example, the carbon precursor can be present in a concentration of from about 3 vol % to about 5 vol %, from about 4 vol % to about 5 vol %, from about 4 vol % to about 10 vol %, from about 4 vol % to about 15 vol %, from about 5 vol % to about 10 vol %, from about 10 vol % to about 15 vol %, from about 3 vol % to about 10 vol %, from about 3 vol % to about 15 vol %, or from about 5 vol % to about 15 vol %.

In a further aspect, the carbon precursor can be present in the disclosed compositions in a concentration of at least about 3 vol % of the composition. For example, the carbon precursor can be present in a concentration of at least about 4 vol % of the composition, of at least about 5 vol % of the composition, or at least about 10 vol % of the composition.

In a further aspect, the carbon precursor is present in the disclosed compositions in a concentration less than the concentration of hydrogen. For example, the carbon precursor can be present in a concentration of approximately half, one-third, or one-fourth the concentration of hydrogen.

In a further aspect, the carbon precursor can be present in the disclosed compositions in a concentration approximately five times, ten times, or twenty times the concentration of nitrogen.

4. Nitrogen

In one aspect, the disclosed compositions comprise nitrogen, for example, nitrogen gas (N₂). Generally, nitrogen can be present in a concentration of from about 0.1 vol % to about 20 vol %. For example, nitrogen can be present in a concentration of from about 0.1 vol % to about 0.5 vol %, from about 0.1 vol % to about 1 vol %, from about 0.1 vol % to about 2 vol %, from about 0.1 vol % to about 3 vol %, from about 0.1 vol % to about 5 vol %, from about 0.1 vol % to about 10 vol %, from about 0.1 vol % to about 15 vol %, from about 0.3 vol % to about 0.5 vol %, from about 0.3 vol % to about 1 vol %, from about 0.3 vol % to about 2 vol %, from about 0.3 vol % to about 3 vol %, from about 0.3 vol % to about 5 vol %, from about 0.3 vol % to about 10 vol %, from about 0.3 vol % to about 15 vol %, from about 0.3 vol % to about 20 vol %, from about 0.5 vol % to about 1 vol %, from about 0.5 vol % to about 2 vol %, from about 0.5 vol % to about 3 vol %, from about 0.5 vol % to about 5 vol %, from about 0.5 vol % to about 10 vol %, from about 0.5 vol % to about 15 vol %, from about 0.5 vol % to about 20 vol %, from about 1 vol % to about 2 vol %, from about 1 vol % to about 3 vol %, from about 1 vol % to about 5 vol %, from about 1 vol % to about 10 vol %, from about 1 vol % to about 15 vol %, from about 1 vol % to about 20 vol %, from about 5 vol % to about 10 vol %, from about 5 vol % to about 15 vol %, from about 5 vol % to about 20 vol %, from about from about from about 10 vol % to about 15 vol %, from about 15 vol % to about 20 vol %, or from about 10 vol % to about 20 vol %.

In a further aspect, nitrogen can be present in a concentration of approximately one-fifth, one-tenth, or one-twentieth the concentration of carbon precursor.

5. Other Components

While, in one aspect, the disclosed compositions can comprise a noble gas component, hydrogen, a carbon precursor, and nitrogen, it is also understood that the disclosed composition can further comprise other components. For example, the disclosed compositions can further comprise water, oxygen, halogens, halogenated compounds, semimetals, metals, and/or the like in order to modify the properties of the plasma composition or of the resultant films. In one aspect, the compositions are substantially free of water.

However, in a further aspect, the disclosed compositions do not include components other than a noble gas component, hydrogen, a carbon precursor, and nitrogen that affect the basic and novel properties of the compositions. That is, the disclosed compositions can consist essentially of a noble gas component, hydrogen, a carbon precursor, and nitrogen. In an even further aspect, the disclosed compositions do not include components other than a noble gas component, hydrogen, a carbon precursor, and nitrogen. That is, the disclosed compositions can consist of a noble gas component, hydrogen, a carbon precursor, and nitrogen.

### D. METHODS OF PRODUCING ULTRA SMOOTH NANOSTRUCTURED DIAMOND FILMS

The methods disclosed herein can employ the disclosed compositions to produce the disclosed films. Generally, in one aspect, the disclosed methods can comprise the steps of providing a mixture comprising a noble gas, hydrogen, a carbon precursor, and nitrogen, establishing a plasma comprising the mixture; and depositing carbon-containing species from the plasma onto the surface, thereby producing a film on the surface. In a further aspect, in the disclosed methods, the noble gas and the nitrogen can be present in combined concentration of less than about 80 vol % of the mixture. In a yet further aspect, in the disclosed methods, the carbon precursor can be present in a concentration of at least about 4 vol % of the mixture. In a still further aspect, in the disclosed methods, the carbon precursor is present in a concentration of from about 4 vol % to about 15 vol %, for example, from about 5 vol % to about 15 vol %, of the mixture.

In a further aspect, the disclosed methods can comprise the steps of: providing a mixture comprising a noble gas, hydrogen, a carbon precursor, and nitrogen, wherein the carbon precursor is present in a concentration of at least about 4 vol % of the mixture; establishing a plasma comprising the mixture; and depositing the plasma on a surface, thereby producing a film on the surface. In a yet further aspect, in the disclosed methods, the carbon precursor can be present in a concentration of from about 4 vol % to about 15 vol %, for example, from about 5 vol % to about 15 vol %, of the mixture. In a still further aspect, in the disclosed methods, the noble gas and the nitrogen can be present in combined concentration of less than about 80 vol % of the mixture or of less than about 75 vol % of the mixture. In an even further aspect, in the disclosed methods, the carbon precursor is present in a concentration of at least about 10 vol % of the mixture.

In a further aspect, the disclosed methods can comprise the steps of: providing a mixture comprising a noble gas, hydrogen, a carbon precursor, and nitrogen, wherein the carbon precursor is present in a concentration of at least about 10 vol % of the mixture, and wherein the noble gas and the nitrogen are present in combined concentration of less than about 75 vol % of the mixture; establishing a plasma comprising the mixture; and depositing carbon-containing species from the plasma onto the surface, wherein the surface comprises Ti-6Al-4V, thereby producing an ultra smooth nanostructured diamond film on the surface. In a yet further aspect, in the disclosed methods, nitrogen can be present in a concentration of from about 0.1 vol % to about 20 vol % of the mixture.

Also disclosed herein are the products produced by the disclosed methods.

1. Providing the Disclosed Compositions

Providing the various disclosed components can be accomplished by any method(s) known to those of skill in the art. Generally, the disclosed compositions can be used to establish a plasma according to the disclosed methods. Also, the disclosed plasmas can be used to deposit the disclosed films.

2. Establishing a Plasma

As used herein, plasma means any plasma wherein energy is imparted to a gas mixture by any of the usual forms of forming a plasma. A DC arc, an RF discharge, a plasma jet, a microwave, a laser beam, an electron beam, or a combination thereof can be used as an energy source to create the plasma disclosed herein. While microwave plasma chemical vapor deposition (MPCVD) has been used to describe herein the plasma source and deposition method, this method is not limiting, and the disclosed compositions, methods, and films can be used in connection with any method for establishing a plasma known to those of skill in the art.

In one example, a microwave plasma enhanced CVD system (ASTeX PDS-17) can be employed for the nanostructured diamond film preparations. The disclosed compositions can be used as the reactant gases for the microwave discharges.

The disclosed plasma compositions can have several advantages over conventional plasmas. For example, the inclusion of a noble gas in the compositions generally results in a larger volume plasma composition. Thus, plasma compositions comprising a noble gas component can provide deposition over a larger surface than conventional plasma.

3. Deposition of Carbon-Containing Species

In one aspect, the depositing step can comprise direct contact between the plasma and the surface. That is, carbon-containing species from the plasma are deposited directly from the plasma onto the surface.

In a further aspect, the depositing step can be performed wherein the surface is spaced from the plasma, and carbon-containing species are ejected from the plasma, travel through the intermediary space, and are deposited onto the surface. Optionally, the carbon-containing species ejected from the plasma can be heated to maintain their energy until the species are deposited onto the surface.

4. Surfaces

The disclosed compositions and methods can be used in connection with the surface of a substrate. That is, the disclosed plasma compositions produce carbon-containing species that can be deposited from the plasma onto the surface, thereby producing a film on the surface of the substrate. The surface can be any exposed surface of the substrate. In particular, the surface can be any surface on the exterior of the substrate. For example, in one aspect, the surface can be the top, bottom, or side surface(s) of the substrate. In further aspects, the surface can be the exposed surface(s) of a pore, a channel, a pattern, or a surface feature. In one aspect, the surface can be a smooth, substantially planar surface. In further aspects, the surface can be curved, angled, spherical, or patterned.

In one aspect, the carbon-containing species produced by the disclosed plasma compositions can be deposited on the entire surface of the substrate. In a further aspect, the carbon-containing species produced by the disclosed plasma compositions can be deposited on a portion of the surface of a substrate. In one aspect, a portion of the surface of the substrate can be covered with a “mask” prior to deposition; after deposition, the “mask” is removed, thereby providing a patterned film on the portion(s) of the surface of the substrate.

While a Ti-6Al-4V alloy substrate has been used to describe herein a surface suitable for deposition of the disclosed plasmas in order to produce the disclosed films, this surface is not limiting, and the disclosed compositions, methods, and films can be used in connection with any surface known to those of skill in the art suitable for plasma deposition. For example, in one aspect, the surface can comprise at least one of zirconium, titanium, aluminum, molybdenum, vanadium, niobium, cobalt, chrome, silicon, silicon oxide, aluminum oxide, zirconium oxide, or titanium oxide, or a mixture thereof, an alloy thereof, or a composite thereof.

In a further aspect, the surface can comprise at least one nitride or carbide of silicon, zirconium, titanium, aluminum, tungsten, molybdenum, vanadium, niobium, boron, or tantalum. For example, the surface can comprise one or more of SiC, Si₃N₄, TiC, WC, BN, TiN, TiBN, or AlTiN.

In a further aspect, the surface can comprise a polymer wherein the polymer has a melting point or a decomposition point of at least 100° C., for example, of at least 250° C., of at least 300° C., or of at least 350° C. For example, in one aspect, the polymer can comprise at least one of a fluoropolymer, a polyamide, a polyimide, a polysulfone, a polyphenylsulfone, a polyamideimide, an epoxy, a polyphenol, a polyvinyl ester, a polycyanate ester, a polybismaleimide, a polyphenylene oxide, or a polymaleic anhydride, or a mixture thereof, or a composite thereof.

In a further aspect, the surface can comprise an alloy. For example, the alloy can be at least one of Ti-6Al-4V, Ti-13Nb-13Zr, CoCr, CoCrMo, or steel, or a mixture thereof, or a composite thereof.

Optionally, before deposition, the surface can be prepared to receive the disclosed films by polishing to ensure a satisfactory starting surface smoothness. For example, the surface can be polished by one of many methods known to those of skill in the art, for example, mechanical polishing with fine powder, such as diamond, silica, or alumina; chemical-mechanical polishing; chemical etching; or solid state diffusion.

In a further aspect, optionally, before deposition, the surface can be pre-treated to “seed” the surface of the substrate with diamond particles or diamondoid particles. For example, the surface can be pre-treated by ultrasonic agitation in a solution containing from about 0.05 μm to about 40 μm diamond particles, or by mechanical polishing/agitation with from about 0.05 μm to about 40 μm diamond particles. As a further example, the surface can be pre-treated by ultrasonic agitation in a solution containing from about 0.004 μm to about 40 μm diamond particles, or by mechanical polishing/agitation with from about 0.004 μm to about 40 μm diamond particles.

In a yet further aspect, optionally, before deposition, the surface can be modified by creating surface defects. For example, the surface can be modified by scratching or sand blasting.

In an even further aspect, optionally, before deposition, the surface can be prepared, pre-treated, and/or modified by using one or more of the above-described techniques, alone or in combination.

### E. ULTRA SMOOTH NANOSTRUCTURED DIAMOND FILMS

Generally, nanostructured diamond is a composite material, which consists of small sp³ nano-crystals of diamond embedded into an amorphous sp² and sp³ carbon matrix. The amorphous matrix, therefore, can play a role in the mechanical, electrical, and other properties of nanostructured diamond films. In the disclosed films, the size of diamond nanocrystals and relative sp²/sp³ content in an amorphous matrix can be controlled by plasma chemistry, particularly by the addition of noble gases to the feedgas mixture. For example, the transition from micro- to nanocrystalline diamond film can be observed when relatively high concentrations of argon are added to H₂/CH₄ plasma. In this example, these significant changes in film morphology can be correlated with a simultaneous 10-20 fold increase in the optical emission intensity of C₂ dimer. Without wishing to be bound by theory, it is believed that the effect of noble gas-induced nanocrystallinity can be explained by the change from CH₃ radical diamond growth mechanism at low noble gas contents to C₂ mechanism at high argon contents.

In one aspect, the disclosed films can be ultra smooth nanostructured diamond films. The disclosed films generally can exhibit an average grain size of less than about 20 nm, for example, less than 15 nm, less than 10 nm, less than 8 nm, less than 6 nm, or less than 5 nm.

In a further aspect, the films can have an average grain size of from about 3 nm to about 9 nm, for example, from about 5 nm to about 6 nm, and an RMS surface roughness of from about 5 nm to about 14 nm, for example, from about 5 nm to about 10 nm, or from about 5 nm to about 10 nm. In a further aspect, the films can have an average grain size of from about 5 nm to about 6 nm and an RMS surface roughness of from about 5 nm to about 10 nm, before polishing of the film. In a further aspect, the films can have an average grain size of from about 3 nm to about 9 nm and an RMS surface roughness of from about 5 nm to about 14 nm, before polishing of the film. In a further aspect, the films can have an average grain size of from about 5 nm to about 6 nm and the RMS surface roughness is from about 8 nm to about 10 nm, before polishing of the film.

In a further aspect, the films can have an average grain size of from about 3 nm to about 9 nm, for example, from about 5 nm to about 6 nm; an RMS surface roughness of from about 5 nm to about 14 nm, for example, from about 5 nm to about 10 or from about 8 nm to about 10; and a relative diamond crystallinity of at least about 30%. In a yet further aspect, the films can have an average grain size of from about 3 nm to about 9 nm, for example, from about 5 nm to about 6 nm; an RMS surface roughness of from about 5 nm to about 14 nm, for example, from about 5 nm to about 10 or from about 8 nm to about 10; and a relative diamond crystallinity of up to about 70%. In a still further aspect, the films can have an average grain size of from about 3 nm to about 9 nm, for example, from about 5 nm to about 6 nm; an RMS surface roughness of from about 5 nm to about 14 nm, for example, from about 5 nm to about 10 or from about 8 nm to about 10; and a relative diamond crystallinity of from about 30% to about 70%, for example, from about 40% to about 60%. In one aspect, the films can have an average grain size of from about 5 nm to about 6 nm, an RMS surface roughness of from about 8 nm to about 10 nm before mechanical polishing of the film, a relative diamond crystallinity of from about 40% to about 60%, and a hardness of from about 50 GPa to about 100 GPa, for example, of from about 58 GPa to about 72 GPa.

### F. CARBON-BASED FILMS

In a further aspect, the disclosed films can be carbon-based films. Carbon-based films include polycrystalline diamond films, nanostructured diamond films, and amorphous carbon films, also known as diamond-like carbon (DLC) films. In general, these films comprise carbon-based film structures that can differ in proportion of carbon crystallinity and/or ratio of sp³ to sp² content. That is, the carbon matrix of the various types of films can differ in proportion of relatively amorphous or crystalline structures of sp³ character and relatively amorphous or graphitic structures of sp² character.

In one aspect, the disclosed compositions and methods can be used to produce carbon-based films. The disclosed carbon-based films can, in further aspects, have the disclosed properties, in particular, the disclosed average grain sizes, disclosed RMS surface roughness, the disclosed hardness, the disclosed relative diamond crystallinity, and the disclosed surface adhesion. For example, the disclosed films can be carbon-based films having an RMS surface roughness of less than about 14 nm, for example, from about 5 nm to about 6 nm, and a hardness of at least about 50 GPa. In another example, the disclosed films can be carbon-based films having a hardness of at least about 70 GPa, for example, at least about 75 GPa, at least about 80 GPa, at least about 85 GPa, at least about 88 GPa, at least about 90 GPa, at least about 95 GPa, or at least about 100 GPa. In another example, the disclosed films can be carbon-based films having a hardness of from about 58 GPa to about 72 GPa.

### G. PROPERTIES OF THE FILMS

The disclosed films possess various properties, including but not limited to average grain size, RMS surface roughness, hardness, relative diamond crystallinity, and surface adhesion. In particular, the disclosed films possess unexpectedly superior properties, in comparison with films produced by conventional methods from conventional compositions.

1. Average Grain Size

Smoothness of the film surface can be related to the average grain size of the nanocrystallites in the disclosed nanostructured diamond films. Generally, the smaller the average grain size, the smoother the film.

Average grain size can be calculated by using the Scherer Equation:

Crystallite Size=K×λ/FW×Cos q

where K is the shape factor of the average crystallite, λ, is the X-ray wavelength, and q is the peak angle position.

In generally, the disclosed compositions and methods can produce films having and average gain size of the nanocrystallites in the film of less than about 20 nm, for example, less than 15 nm, less than 10 nm, less than 8 nm, less than 6 nm, or less than 5 nm. For example, the average gain size can be from about 3 nm to about 8 nm, from about 5 nm to about 6 nm, from about 3 nm to about 5 nm, from about 3 nm to about 6 nm, from about 5 nm to about 8 nm, or from about 6 nm to about 8 nm.

The disclosed films can possess these average grain sizes in the absence of polishing subsequent to deposition of the film or before polishing subsequent to deposition of the film. It is understood that the films can be modified after deposition to provide an even smoother surface and/or smaller average grain size.

2. RMS Surface Roughness

Roughness consists of surface irregularities, which combine to form surface texture. RMS surface roughness of the disclosed nanostructured diamond films is a measure of the smoothness of the film surface. Surface roughness is inversely proportional to the smoothness of the film. Generally, the lower the RMS surface roughness, the smoother the film.

RMS surface roughness can be calculated, for example, using surface irregularity size measurements taken from examination of AFM topography images. RMS surface roughness is defined as the square root of the arithmetic mean of the square of the surface irregularity measurements. Generally, the RMS surface roughness is greater than the simple arithmetic average surface roughness.

In one aspect, the disclosed films can have an RMS surface roughness of from about 5 nm to about 14 nm, for example, from about 6 nm to about 13 nm, from about 7 nm to about 12 nm, from about 8 nm to about 11 nm, from about 9 nm to about 10 nm, from about 5 nm to about 13 nm, from about 5 nm to about 12 nm, from about 5 nm to about 11 nm, from about 5 nm to about 10 nm, from about 5 nm to about 9 nm, from about 5 nm to about 8 nm, from about 5 nm to about 7 nm, from about 6 nm to about 14 nm, from about 7 nm to about 14 nm, from about 8 nm to about 14 nm, from about 9 nm to about 14 nm, from about 10 nm to about 14 nm, from about 11 nm to about 14 nm, from about 12 nm to about 14 nm, from about 13 nm to about 14 nm, from about 6 nm to about 8 nm, or from about 8 nm to about 10 nm.

The disclosed films can possess these levels of smoothness in the absence of polishing subsequent to deposition of the film or before polishing subsequent to deposition of the film. It is understood that the films can be modified after deposition to provide an even smoother surface. That is, the surfaces of the disclosed films can be polished by one of many methods known to those of skill in the art, for example, mechanical polishing with fine diamond powder, chemical etching, or solid state diffusion, thereby decreasing the RMS surface roughness of the surface of the film.

3. Hardness

Hardness is one measure of the strength of the structure of a material. Hardness of a material can be tested through scratching with a harder material or, as here, through nanoindentation with a NanoIndenter XP system.

In one aspect, the disclosed films can have a hardness of at least about 50 GPa, for example, at least about 55 GPa, at least about 60 GPa, at least about 65 GPa, at least about 70 GPa, at least about 75 GPa, at least about 80 GPa, at least about 85 GPa, at least about 88 GPa, at least about 90 GPa, at least about 95 GPa, or at least about 100 GPa. In a further aspect, the hardness can be from about 50 GPa to about 100 GPa, from about 50 GPa to about 90 GPa, from about 60 GPa to about 80 GPa, from about 50 GPa to about 70 GPa, from about 55 GPa to about 75 GPa, from about 65 GPa to about 85 GPa, from about 50 GPa to about 80 GPa, from about 60 GPa to about 90 GPa, or from about 58 GPa to about 72 GPa.

4. Relative Diamond Crystallinity

Relative diamond crystallinity is a measure of the ratio of sp³ nanocrystalline diamond content to sp²/sp³ amorphous carbon content in the nanostructured diamond films. Relative diamond crystallinity is related to the hardness of the film as well as to the surface adhesion of the film. Generally, the greater the relative diamond crystallinity, the greater the hardness. Also generally, in conventional films, the greater the relative diamond crystallinity, the less satisfactory the surface adhesion.

Accordingly, diamond films produced by conventional methods can possess a satisfactory hardness; however, diamond-like carbon films produced by conventional techniques generally possess a less-than-satisfactory hardness.

Relative diamond crystallinity can be measured by XRD analysis of the disclosed nanostructured diamond films and comparison with nearly 100% crystalline polycrystalline diamond films. Such analysis reveals that the disclosed nanostructured films generally have from about 30% to about 70% relative diamond crystallinity. The partially noncrystalline amorphous composition of the nanostructured films is primarily very hard, tetrahedral-coordinated amorphous carbon with small sp²-bonded clusters, or other hard sp² or sp³ carbon amorphous matrix. Without wishing to be bound by theory, it is believed that this amorphous carbon content in the nanostructured diamond film can improve fracture toughness of the films by limiting crack nucleation and by reducing the stress near existing cracks. Therefore, the excellent interfacial adhesion observed for these films (in comparison to crystalline, nanocrystalline, or ultra-nanocrystalline diamond films) can be attributed to a reduction of residual film stress along with an increase in interfacial toughness.

In one aspect, the films can have a relative diamond crystallinity of at least about 30%, for example, a relative diamond crystallinity of at least about 40%, of at least about 50%, of at least about 60%, or of at least about 70%. In a yet further aspect, the films can have a relative diamond crystallinity of up to about 70%, for example, of up to about 60%, for example, of up to about 50%, for example, of up to about 40%, for example, or of up to about 30%. In a further aspect, the films can have a relative diamond crystallinity of from about 30% to about 70%, for example, from about 40% to about 60%, from about 30% to about 50%, from about 50% to about 70%, or of about 50%.

5. Surface Adhesion

Interfacial adhesion, or surface adhesion, is related to relative diamond crystallinity. Surface adhesion can be measured by scratch testing or by indentation with a NanoIndenter XP system during hardness testing and then by observing interface between the film and the substrate surface.

Generally, the greater the relative diamond crystallinity, the higher the residual stress in the film, and the less satisfactory the surface adhesion. Accordingly, diamond-like carbon films produced by conventional methods can possess a satisfactory surface adhesion; however, diamond films produced by conventional techniques, generally posses a relative diamond crystallinity that is too high to prevent fracture or delamination.

In contrast, while maintaining a satisfactory hardness, the disclosed films exhibit improved interfacial adhesion and toughness, compared to films produced by conventional methods. The films herein are generally well adhered to the substrate surface, even in the presence of significant mechanically- or thermally-induced stress, such as during the cutting of hard materials (hard graphite, A1390 alloy) by the WC cutter coated with the diamond film.

6. Film Thickness

Deposited films can vary in film thickness. The thickness of a film is determined by time of exposure (CVD time) and a growth rate (film), which depend upon various factors, including microwave power, plasma chemistry, and substrate temperature. In conventional CVD methods, the grain size, surface morphology, and surface roughness of the diamond films can depend strongly on the film thickness. Generally, the thicker the film, the larger the grain size and the rougher the surface of the film. In contrast, the disclosed compositions and methods can produce the disclosed films with superior small average gain size and superior smoothness, independent of film thickness.

Generally, the disclosed films can be produced at any desired thickness. In one aspect, the disclosed films can be produced at a thickness of about 1.5 μm.

In a further aspect, the films can have thicknesses of from about 0.1 μm to about 30 μm, for example, of from about 0.5 μm to about 3 μm, of from about 1 μm to about 2 μm, of from about 1 μm to about 5 μm, of from about 0.1 μm to about 0.5 μm, of from about 0.1 μm to about 1 μm, of from about 1 μm to about 3 μm, of from about 2 μm to about 5 μm, of from about 5 μm to about 10 μm, of from about 5 μm to about 15 μm, of from about 5 μm to about 20 μm, of from about 5 μm to about 25 μm, of from about 5 μm to about 30 μm, of from about 10 μm to about 15 μm, of from about 10 μm to about 20 μm, of from about 10 μm to about 25 μm, of from about 10 μm to about 30 μm, of from about 15 μm to about 20 μm, of from about 15 μm to about 25 μm, of from about 15 μm to about 30 μm, of from about 20 μm to about 25 μm, of from about 20 μm to about 30 μm, or of from about 25 μm to about 30 μm. In a yet further aspect, the films can have thicknesses of from about 0.1 μm to about 50 μm, for example, of from about 5 μm to about 50 μm, of from about 10 μm to about 50 μm, of from about 20 μm to about 50 μm, of from about 30 μm to about 50 μm, or of from about 40 μm to about 50 μm.

In a yet further aspect, the films can have thicknesses of greater than about 30 μm, for example, of from about 30 μm to about 100 μm, of from about 30 μm to about 50 μm, of from about 50 μm to about 100 μm, of from about 40 μm to about 60 μm, of from about 30 μm to about 70 μm. In an even further aspect, the films can have thicknesses of greater than about 100 μm, for example, of about 150 μm, of about 200 μm, of about 300 μm, or of about 500 μm. In a still further aspect, the films can have thicknesses of greater than about 50 μm, for example, of from about 50 μm to about 100 μm, of from about 50 μm to about 70 μm, of from about 70 μm to about 100 μm, of from about 60 μm to about 80 of from about 50 μm to about 90 μm. In an even further aspect, the films can have thicknesses of about 1 mm or of about 10 mm.

### H. APPLICATIONS

Generally described, in further aspects, the disclosed films can be used to produce abrasion resistant cutting tools; low wear rate coatings on biomedical devices and implants; high thermal conductivity, high temperature substrates for high power electronic circuits; wide diamond-coated wafers for electronic, optoelectronic, and optical devices; high temperature, ultra-high frequency, high power, high radiation, high-stability transistors; wide optical range windows, wear resistant optical windows; substrates for surface acoustic wave devices; low corrosion, high electrode potential window substrates (electrodes) for biological and/or chemical sensors; and substrates for microelectromechanical or nanoelectromechanical systems (MEMS/NEMS) devices.

It is understood that the disclosed compositions, methods, and films are not limited to particular applications or products. In particular, the disclosed films can be used in any applications or products of diamond, DLC, or carbon-based films that are known to those of skill in the art. However, in one aspect, the disclosed films can be used to produce coated medical instruments or medical implants. In particular, nanostructured diamond films on metal implants can provide high hardness, low friction, and wear-resistant coatings, which also are very stable under severe physiological conditions.

In one aspect, the disclosed films can be used to produce coated medical implants. In particular, the coated medical implants can include, but are not limited to, a femoral head implant, a hip socket implant, a knee implant, or a plate. In further aspects, the disclosed films can be used to produce coated magnetic storage media. In a yet further aspect, the disclosed films can be used to produce a coated recording head in a magnetic storage media. In further aspects, the disclosed films can be used to produce coated cutting or drilling tools.

### I. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The addition of a noble gas, for example, helium, to a relatively high CH₄ content H₂/CH₄/N₂ feedgas mixture (10.7 vol % CH₄ and 1.07 vol % N₂) for microwave plasma chemical vapor deposition produced hard (58-72 GPa), ultra-smooth nanostructured diamond films on Ti-6Al-4V alloy substrates. Upon increase in He content up to 71 vol %, root mean squared (RMS) surface roughness of the film decreased to 8-10 nm and average diamond grain size to 5-6 nm. Without wishing to be bound by theory, it is believed that this increased nanocrystallinity can be related to plasma dilution, enhanced fragmentation of carbon containing species, and enhanced formation of CN radical.

### 1. Film Deposition Procedure

Nanostructured diamond films of about 1.5 μm thickness were deposited by microwave plasma chemical vapor deposition (MPCVD) on 7 nm diameter Ti-6Al-4V disks, which were initially polished to 4-5 nm RMS surface roughness and treated by ultrasonic agitation in a 1 μm diamond powder/water solution. The total flow rate of He and H₂ gases was fixed at 300 standard cubic centimeters per minute (scum) and their ratio changed, thereby providing variation from 0 to 71 vol % He. The flow rates of CH₄ and N₂ were kept constant at 36 and 3.6 sccm (10.7 vol % and 1.07 vol %), respectively. The chamber pressure was 65 Torr and the substrate temperature, as measured by a two-color IR pyrometer, was kept in the range 700-740° C. by adjusting the microwave power in the range 0.8-0.95 kW. The concentration of plasma species was monitored by optical emission spectroscopy (OES). Glancing angle X-ray diffraction (XRD) with 4° incident beam was used to determine the crystalline structure of the films. The growth rate of the resultant nanostructured diamond film was determined from in situ optical interferometry.

### 2. Film Properties

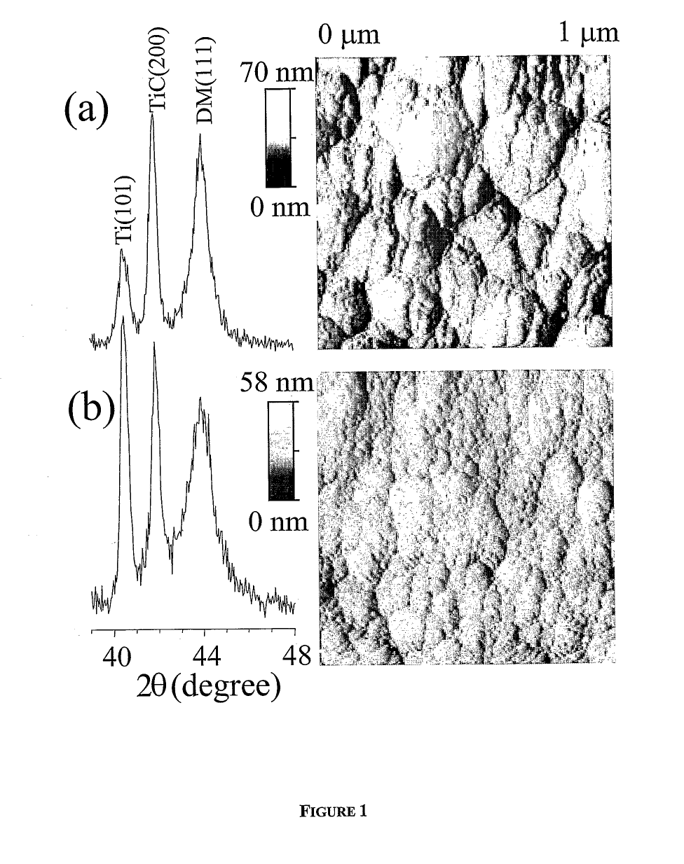

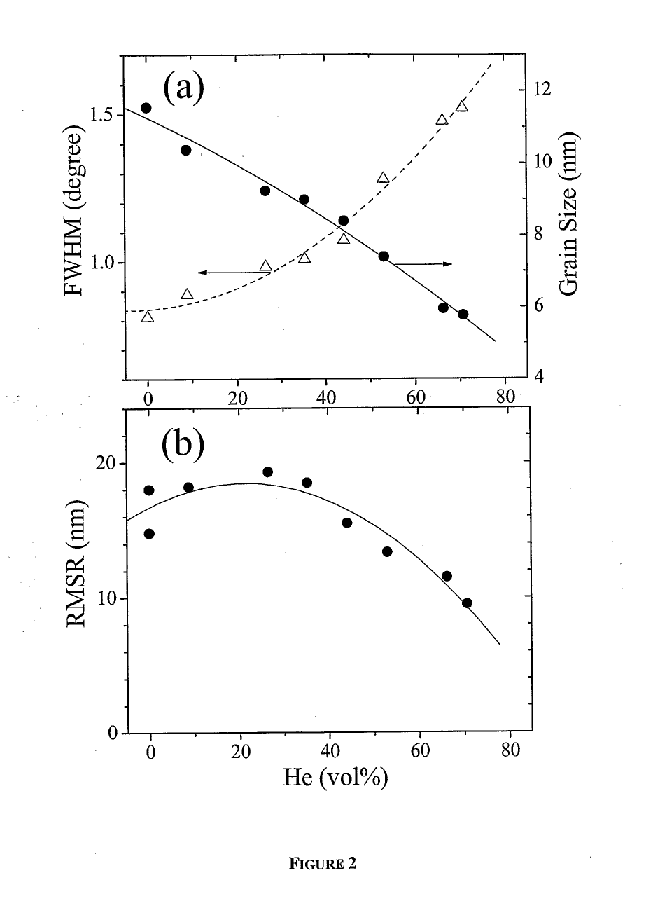

FIGS. 1a and 1b show AFM images and XRD 20-angular dependencies of two films grown with 0 and 71 vol % He. AFM images demonstrate that the film grown with 71 vol % He consists of small 20-30 nm nanoparticles and the film grown without He consists of larger 30-100 nm nanoparticles. In addition, the XRD peak of (111) cubic diamond is much broader for the film grown with 71 vol % He. Note, that XRD analysis of all deposited films detected broad (111), (220) and (311) peaks of cubic diamond, and no other carbon related peaks. The significant broadening of the diamond peaks upon the addition of noble gas is related to the smaller average grain size of diamond nanocrystals. The average grain size of diamond was estimated from the full width at half maximum (FWHM) of the (111) diamond peak using the Scherrer equation (after correction for instrumental broadening) and presented in FIG. 2, together with the surface roughness of the films calculated from 2×2 μm AFM images.

An increase in He content results in a near linear decrease of diamond grain size from 11-13 nm to 5-6 nm. The surface roughness remains constant at 15-18 nm, or may be slightly increased, up to 30 vol % He, and decreased to 9-10 nm at 71 vol % He. The difference between particle sizes on the AFM image and calculated diamond grain sizes indicates that diamond nanocrystals are agglomerated into larger particles. The addition of He reduced the size of diamond nanocrystals as well as the degree of their agglomeration.

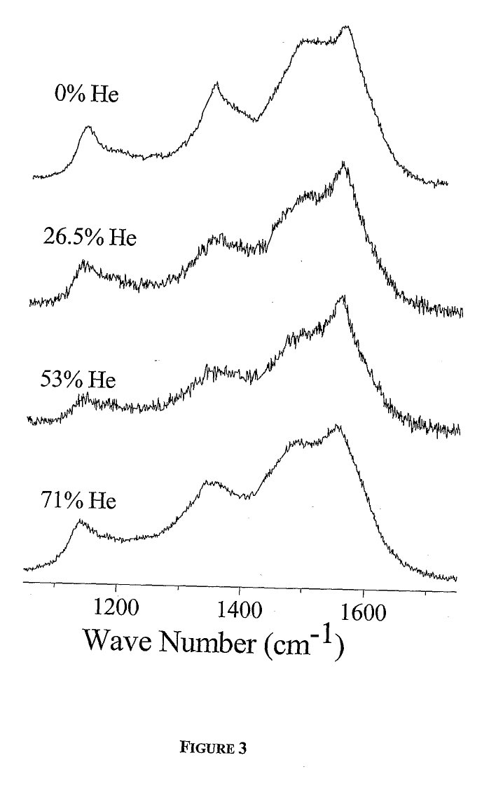

Micro-Raman spectra for the films at various He contents are present in FIG. 3 and show broad peaks at 1137, 1340, 1485, and 1550 cm⁻¹, which are typically observed for nanostructured diamond films containing sp² and sp³ bonded carbon. A broad 1340 cm⁻¹ peak is a characteristic of nano-crystalline diamond, and a broad 1550 cm⁻¹ peak was observed in high hardness tetrahedral amorphous carbon films. In this example, the addition of He resulted in a broader 1340 cm⁻¹ peak and did not result in any significant changes in other Raman peaks.

The hardness and Young's modulus of the films were measured using a Nanoindenter XP system (MTS Systems, Oak Ridge Tenn.), which was calibrated by using a silica standard. The system was calibrated by using silica samples for a range of operating conditions. Silica Young's modulus and hardness were calculated as 70 GPa and 9.1 GPa and 69.6 GPa and 9.4 GPa, respectively, before and after indentation on diamond samples. A Berkovich diamond indenter with total included angle of 142.3° was used for these measurements. The maximum indentation depth was 150 nm. Nanoindentation showed that the hardness and Young's modulus of the films do not decrease up to 71 vol % He, and are in the range of 58-72 GPa and 380-480 GPa, respectively.

### 3. Proposed Mechanism of Growth

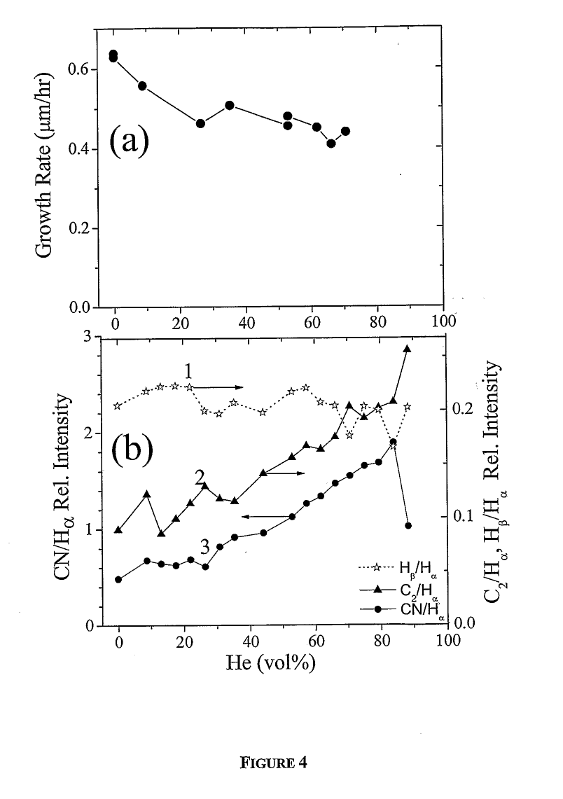

Optical emission spectroscopy (OES) was used to monitor any changes in plasma chemistry upon He addition. FIGS. 4a and 4b show the growth rate of diamond film and the ratios of OES intensities of plasma species (CN/H_{α}, C₂/H_{α}, and H_{β}/H_{α}) as a function of added He. FIG. 4a shows a steady drop of the growth rate from 0.63 μm/hr to 0.45 μm/hr up to 71 vol % He. FIG. 4b shows that, upon He addition, the ratio H_{β}/H_{α} remains practically constant, indicating only minor changes in plasma temperature. The ratio C₂/H_{α} increases about 2 times, and the ratio CN/H_{α} increases about 3 times.

Without wishing to be bound by theory, it is believed that the effect of noble gas, for example, helium, addition on reducing diamond grain size suggests that the rate of secondary nucleation/renucleation increases in He/H₂/CH₄/N₂ plasma, precluding the growth of large diamond nanocrystals. Without wishing to be bound by theory, it is believed that one effect of He addition is simply the increase in CH₄/H₂ ratio in He/H₂/CH₄/N₂ plasma, which should reduce the effect of hydrogen on suppressing secondary nucleation by regasifying nondiamond carbon. However, our data indicate that the effect of He addition is not a simple effect of plasma dilution, but is instead based on a more complex mechanism. Diamond films grown in H₂/CH₄/N₂ plasma without He, at a correspondingly high CH₄/H₂ ratio of 0.6, have poor quality with high content of graphitic phase. Without wishing to be bound by theory, it is believed that another explanation of the He effect can be related to the known strong influence of the CN radical on the degree of diamond nanocrystallinity. The observed decrease in film roughness above 30 vol % He correlates well with the simultaneous increase in the CN/H_{α} ratio. Nevertheless, the CN mechanism alone does not account for the observed increase in nanocrystallinity. The N₂ content in H₂/CH₄/N₂ plasma above which CN radical influence on nanocrystallinity is diminished, is lower for higher CH₄/H₂ ratios.

OES data indicate that the addition of He to H₂/CH₄/N₂ plasma is different from the addition of Ar. Thus the C₂/H_{α} ratio increased 10 times at 70 vol % Ar and only 2 times at similar He content. Even more pronounced is the observed small increase of C₂/H_{α} ratio at very high He contents of 80-98 vol %, compared to its 10-20 times increase at corresponding high Ar contents. Thus, without wishing to be bound by theory, it is believed that the effect of He addition on reducing the diamond grain size cannot be accounted for by the switching from CH₃ (or C₂H₂) growth mechanism to C₂ mechanism, which was responsible for formation of nanocrystalline diamond at very high 80-99 vol % Ar [D. Gruen, et al].

Without wishing to be bound by theory, it is believed that He plasma has some unique properties which distinguish it from other noble gas plasmas, for example, Ar plasmas. For example, the ionization potential of He is 24.5 eV, which is much higher than that of Ar (15.76 eV) and, in fact, is the highest ionization potential among known elements. In addition, the excitation energy of long-lived (the life-time without quenching is 6×10⁵ s) excited state (2³S) of He atoms is 19.8 eV, compared to 11.55 eV for the much shorter-lived (life-time is 1.3 s) excited (4³P₂) Ar atoms. Thus, long-lived energetic excited He atoms can lead to additional ionization and fragmentation of CH₄ gas via a Penning mechanism. The OES data demonstrate that, in He/H₂/CH₄ plasma, the fragmentation of C₂ dimer can be significantly enhanced compared to Ar/H₂/CH₄ plasma. Without wishing to be bound by theory, it is believed that enhanced fragmentation of C₂ and other carbon containing species in He plasma can suppress the growth of large diamond nanocrystals.

### 4. Experimental Results

The effect of noble gas, for example He, addition to a relatively high 10.7 vol % CH₄ content H₂/CH₄/N₂ microwave plasma using different He/H₂ feedgas ratios was studied. An increase in He content resulted in a decrease of average diamond grain size from about 9-15 nm to about 5-6 nm. At the same time, RMS surface roughness of the film decreased from 15-18 nm to 8-10 nm. Raman spectra, which were typical for nanostructured diamond films, showed no significant changes upon He addition, with exception of 1340 cm⁻¹ diamond peak broadening. Nanoindentation demonstrated that the hardness and Young's modulus of the films do not decrease with increase in He content, and are in the range of 58-72 GPa and 380-480 GPa, respectively. Optical emission data indicate that the fragmentation of C₂ dimer in He-containing plasma can be significantly enhanced compared to Ar/H₂/CH₄ plasma. Thus, the diamond growth by C₂ mechanism, which was responsible for a nanocrystallinity of 80-99 vol % in Ar plasma can be suppressed by He addition. Without wishing to be bound by theory, it is believed that the effect of He addition in reducing diamond grain size and film surface roughness is attributed to plasma dilution, enhanced fragmentation of carbon containing species, and enhanced formation of CN radical.

### 5. Example 1

A nanostructured diamond film of about 1.5 μm thickness was deposited by microwave plasma chemical vapor deposition (MPCVD) on a 7 mm diameter Ti-6Al-4V disk, which was initially polished to 4-5 nm RMS surface roughness and treated by ultrasonic agitation in a 1 μm diamond powder/water solution.

In this example, the noble gas was helium and was present in a concentration of 85.3 vol % of the composition; hydrogen was present in a concentration of 9.53 vol % of the composition; the carbon precursor was methane and was present in a concentration of 4.7 vol % of the composition; and nitrogen was present in a concentration of 0.47 vol % of the composition.

The chamber pressure was 65 Ton and the substrate temperature, as measured by a two-color IR pyrometer, was kept in the range 700-740° C. by adjusting the microwave power in the range 0.8-0.95 kW. The concentration of plasma species was monitored by optical emission spectroscopy (OES). Glancing angle X-ray diffraction (XRD) with 4° incident beam was used to determine the crystalline structure of the films. The growth rate of the resultant nanostructured diamond film was determined from in situ optical interferometry.

The example resulted in an ultra smooth nanostructured diamond film having an RMS surface roughness of 8 nm. In this example, however, the observed film growth rate was approximately half of previous examples.

### 6. Example 2

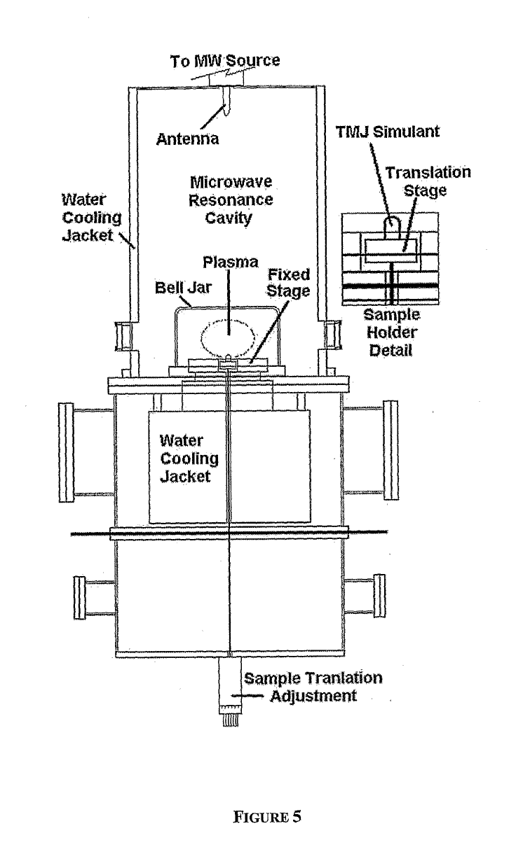

Ti-6Al-4V alloy disks with 25.4 mm diameter and 3.4 mm thickness were punched from Ti-6Al-4V sheets supplied by Robin Materials (Mountain View, Calif.). They were polished to a root-mean-square (RMS) roughness of 3-4 nm using a mechanical polisher with SiC paper, followed by a chemical-mechanical polish with a 0.06 μm colloidal silica solution containing 10% hydrogen peroxide. The polished disks were cleaned by ultrasonic agitation in a 1 micron diamond powder/water solution after a series of detergent solution, methanol, acetone, and finally deionized water. Cleaned substrates were placed in a Wavemat MPCVD reactor, equipped with a 6 kW, 2.4 GHz microwave generator shown in FIG. 5. Chamber pressure was 65 Torr and the substrate temperature, as measured by a Mikron M77LS Infraducer two-color IR pyrometer, was kept in the range 690-720° C. by adjusting microwave power in the range 0.93-1.1 kW. This two-color pyrometer provided accurate measurement of the substrate temperature without requiring correction of the emissivity of the surface during growth. Total flow rate of He, H₂, and CH₄ gases in this example was fixed at 336 seem (71% He in He+H₂, 36 seem of CH₄), and the ratio of N₂/CH₄ gas flow changed from 0 to 0.6.

### a. ANALYSIS

Optical emission spectroscopy (OES) was performed to qualitatively determine the activated species present in the plasma. All the measurements were taken with 3000 points in the range of 350-700 nm wavelength and integration time of 250 ms. The crystallinity of the diamond films was analyzed by micro-Raman spectroscopy. The Raman spectra were taken using the 514.5 nm line of an argon-ion laser focused onto the film at a laser power of 100 mW. The Raman scattered signal was analyzed by a high resolution spectrometer (1 cm⁻¹ resolution) coupled to a CCD system. XRD patterns on the diamond sample were examined using glancing angle XRD (X′pert MPD, Philips, Eindhoven, Netherlands). XRD was performed using a glancing angle of 3-degree incident beam directed at the topmost surface of the coating surface. Spectra were taken from 30 to 90 (2-theta) at a scan speed of 0.012° min⁻¹ and a step size of 0.005° as well as from 40 to 47 (2-theta) in order to clearly document the intensity and Full Width at Half Maximum (FWHM) of the diamond (111) diffraction peak.

Structure and surface morphology of the diamond surfaces was imaged by a TopoMetrix Explorer AFM. The images were collected in non-contact imaging mode. The cantilevers used were High Resonance Frequency (HRF) silicon “I” shaped cantilevers, frequency range 279-318 kHz. The images obtained were processed by TopoMetrix SPM Lab NT Version 5.0 software supplied with the microscope. The processing consists of a second order leveling of the surface and a left shading of the image. Roughness was measured from a 2 μm² scan area consistently for all samples. Surfaces of the diamond film were also imaged by FEI Nova NanoSEM™.

The hardness and elastic modulus of the diamond films was measured using a Nanoindenter XP (MTS Systems, Oak Ridge Tenn.) system with a continuous stiffness attachment such that the loading and unloading displacement rates were constant. This provided continuous hardness/modulus measurements with increasing depth into the film. [B. D. Fabes, W. C. Oliver, R. A. McKee, and F. J. Walker, J. Mater. Res. 7, 3056 (1992); C. J. McHargue, in Applications of Diamond Films and Related Materials, edited by Y. Tzeng, M. Yoshikawa, M. Murakawa, and A. Feldman (Elsevier, Amsterdam, 1991), p. 113.] The system was calibrated by using silica samples for a range of operating conditions. Silica modulus and hardness were calculated as 70 GPa and 9.1 GPa and 69.6 and 9.4, respectively, before and after indentation on diamond samples. The tip functions before and after the indentation were held constant. A Berkovich diamond indenter with total included angle of 142.3° was used and the maximum indentation depth of 150 nm was maintained for all the measurements. The data was processed using proprietary software to produce load-displacement curves and the mechanical properties were calculated using the Oliver and Pharr method. [W. C. Oliver and G. M. Pharr, J. Mater. Res. 7 (1992) 1564.]

### b. RESULTS AND DISCUSSION

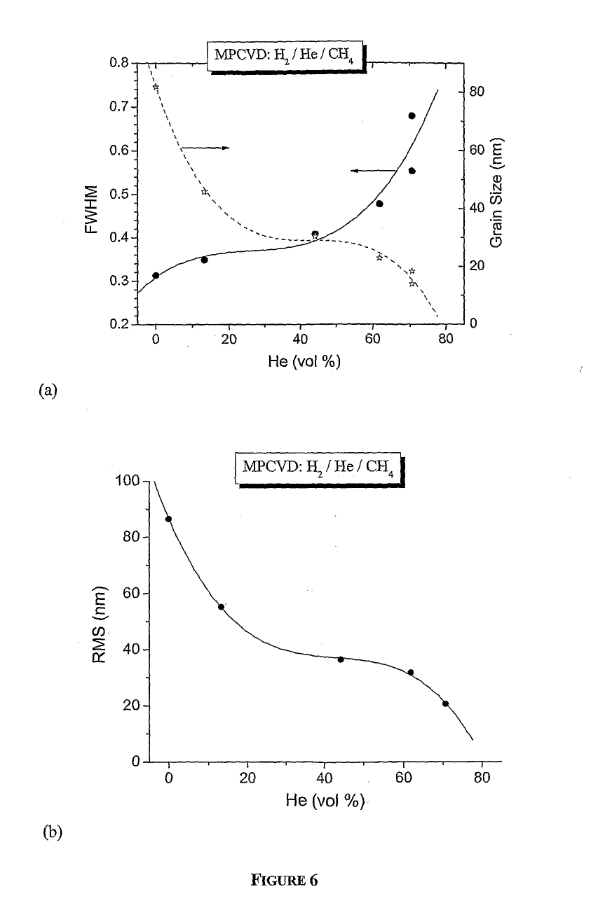

Previously, it was found that with the introduction of helium gas in H₂/CH₄/N₂ plasma, the transformation from microcrystalline to nanocrystalline occurred and roughness decreased dramatically. [V. V Konovalov, A. Melo, S. A Catledge, S. Chowdhury, Y. K. Vohra, J. of Nanosci. and Nanotechnol., 6, 258 (2006).] The roughness decreased from 19-20 nm to 9-10 nm with the introduction of helium up to 71% (in He/H₂ with fixed N₂ and CH₄ ratio 0.1). Helium gas was also introduced in H₂/CH₄ feedgas without N₂ and it was found that the roughness and grain size of the diamond films also decreased with increase of helium content. The RMS roughness was as low as 20 nm and grain size 16-18 nm at helium flow up to 71% (in He/H₂ with fixed CH₄ content), as shown in FIGS. 6a and b. It was found that the combined effect of He and N₂ played a role of decreasing the roughness and grain size and producing ultra smooth nanocrystalline diamond films. [V. V Konovalov, A. Melo, S. A Catledge, S. Chowdhury, Y. K. Vohra, J. Nanosci. Nanotechnol., 6, 258 (2006).]

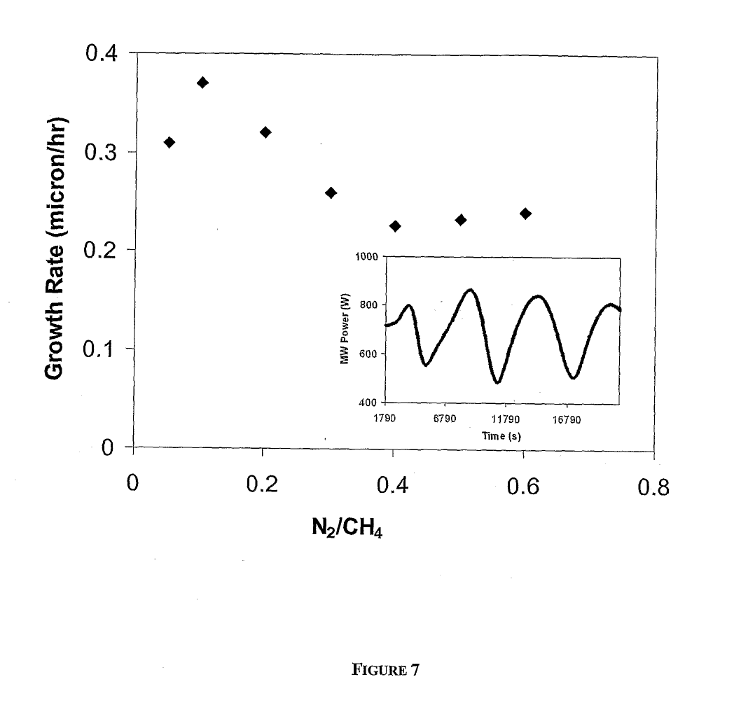

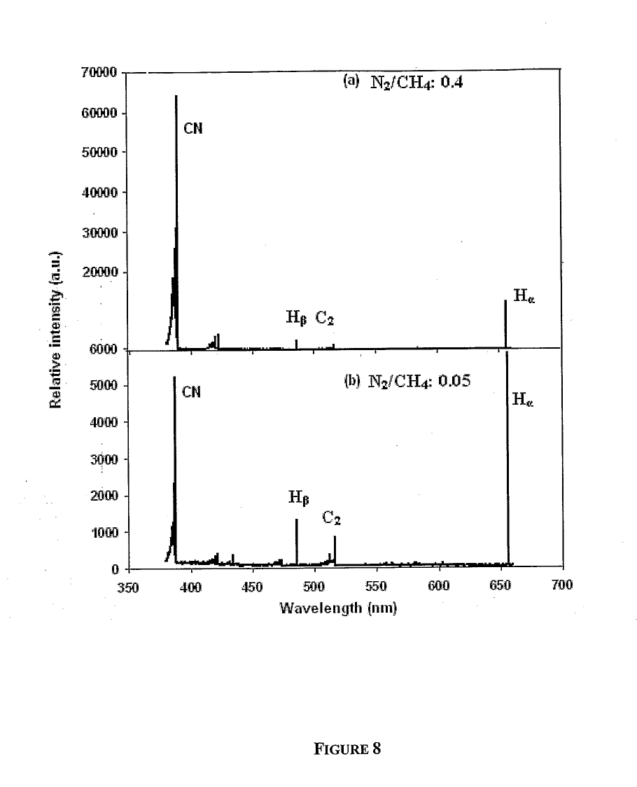

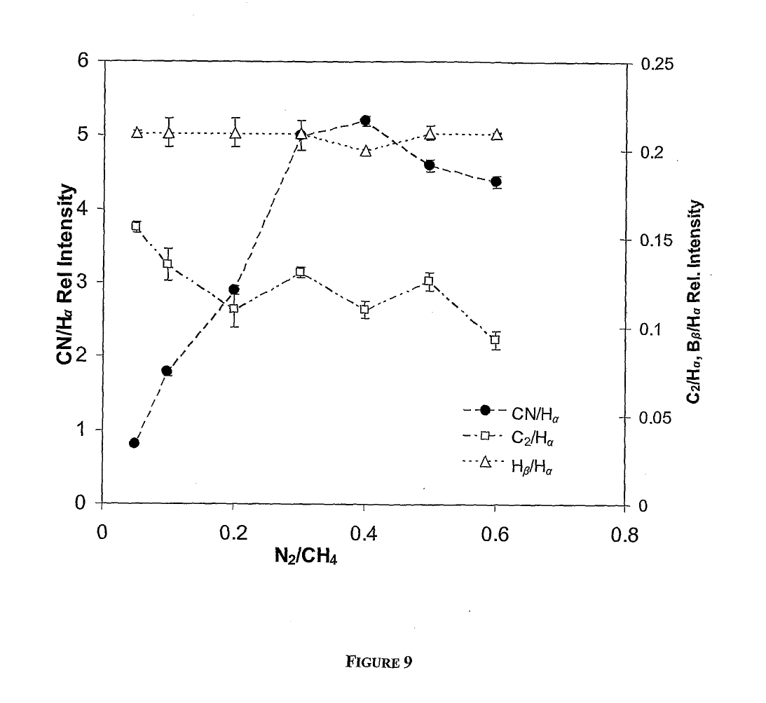

Higher levels of gas phase CN radicals can reduce the CH₃ concentration and thus reduce growth rate. FIG. 7 shows the drop of the growth rate from 0.37 μm/hr to 0.22 μm/hr by changing N₂/CH₄ ratios from 0.05 to 0.6. In the insert of FIG. 7, an optical interference pattern collected from the interferometer is shown for the film deposited at N₂/CH₄ of 0.4. Optical emission spectroscopy was used to monitor the changes in plasma chemistry upon N₂ addition during diamond growth. The optical emission spectra of the He/H₂/CH₄/N₂ microwave plasmas with N₂/CH₄ ratios of 0.05 and 0.4 are shown in FIG. 8. The ratios of OES intensities of plasma species (CN/H_{α}, C₂/H_{α} and H_{β}/H_{α}) as a function of N_{Z}/CH₄ ratio is also shown in FIG. 9. Here, an increase of N₂/CH₄ ratio, the H_{β}/H_{α} remained practically constant, indicating only minor changes in plasma temperature. The ratio C₂/H_{α} remained almost constant as well. The CN/H_{α} ratio increased from 1 to 5 up to the N₂/CH₄ ratio of 0.4, and then decreased afterwards. Previous results [V. V Konovalov, A. Melo, S. A Catledge, S. Chowdhury, Y. K. Vohra, J. Nanosci. Nanotechnol., 6, 258 (2006).] indicated that with increase of He addition up to 71% (in He+H₂) and N₂/CH₄ gas concentration ratio 0.1, there was a 3 fold increase of CN/H_{α}. With the same 71% of He (in He+H₂ gas mixture) addition but N₂/CH₄ gas concentration ratio of 0.4 we had 2.5 times increase of CN/H_{α}. It decreased beyond a N₂/CH₄ ratio of 0.4.

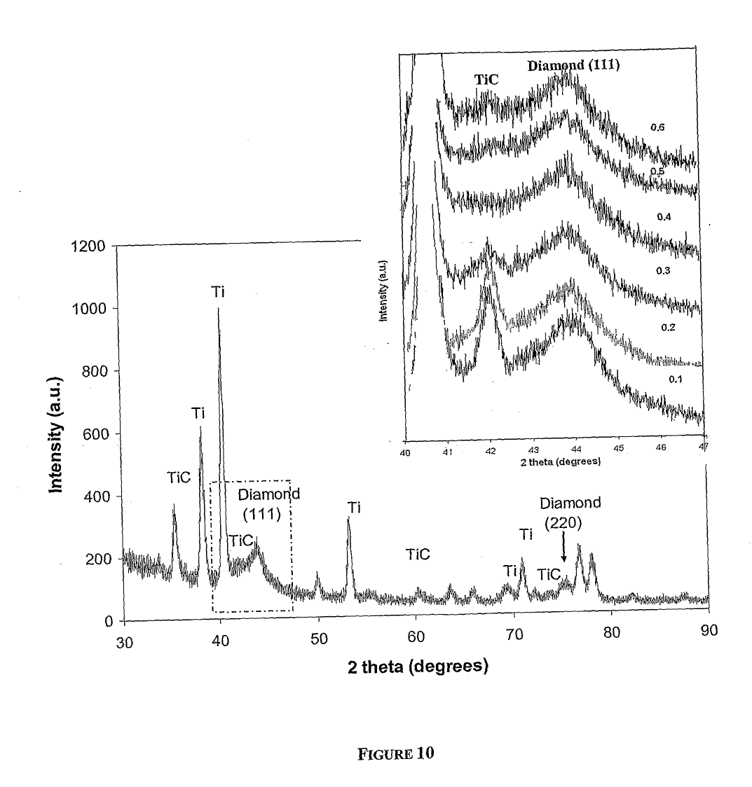

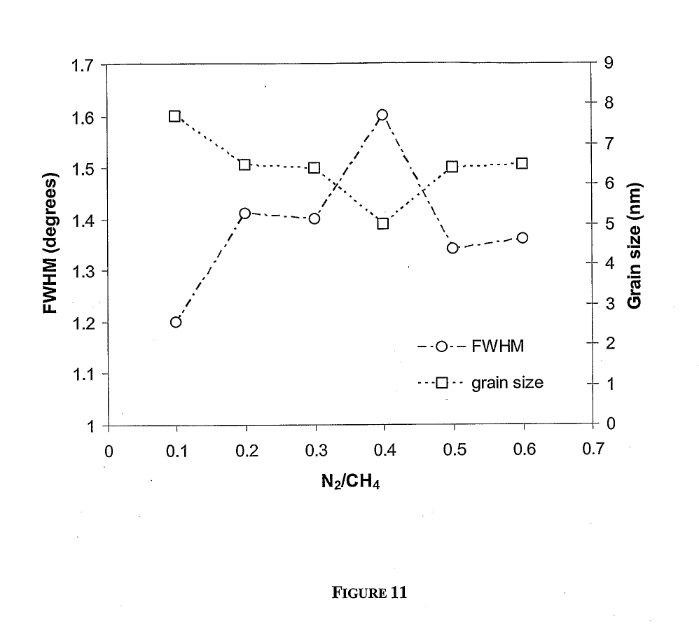

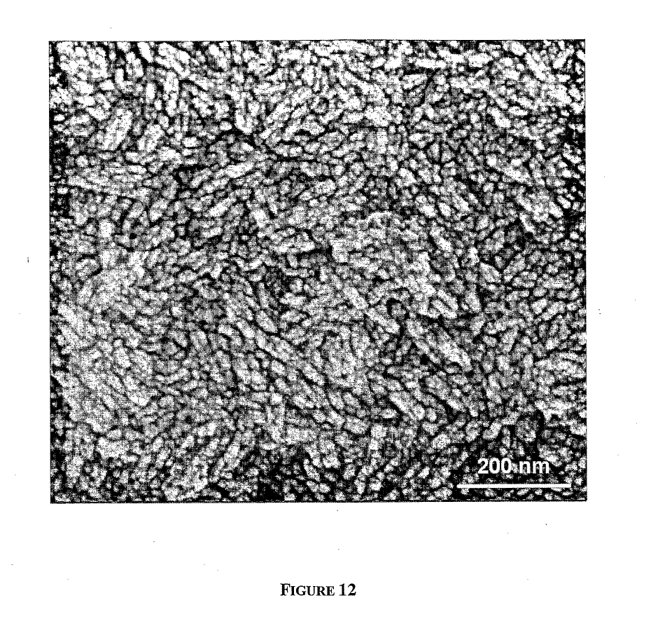

FIG. 10 shows the glancing angle XRD patterns for the nanostructured diamond films grown on Ti-6Al-4V alloy using the He/CH₄/H₂/N₂ feedgas mixture with different N₂/CH₄ ratios. Characteristic of these patterns are the cubic diamond (111) and (220) reflections as well as several peaks attributed to interfacial titanium carbide phases. The diamond peaks (shown in the insert) were significantly broadened as compared to those obtained from the conventional CVD process. The average grain size as calculated from the diamond (111) peak width using the Schemer formula was between 4-8 nm. The grain size decreased to around 4-5 nm as N₂/CH₄ ratio increased up to 0.4 and then increased again. It was also found that as the N₂ content increased the intensity of the (200) diffraction peak from the TiC phase decreased. At N₂/CH₄ of 0.4 there was no TiC peak and the intensity again increased as the ratio N₂/CH₄ increased. The average grain size of diamond films with different N₂/CH₄ concentration ratios was estimated from the full width at half maximum (FWHM) of the (111) diamond peak using Scherrer equation (after correction for instrumental broadening) and presented in FIG. 11. Scanning Electron Microscope (SEM) image at 300,000× on the surface of diamond sample grown in He/H₂/CH₄/N₂ plasma at N₂/CH₄ ratio of 0.4 is shown in FIG. 12. Here, the grain size is as low as 5.7 nm and confirms the diamond nanostructure.

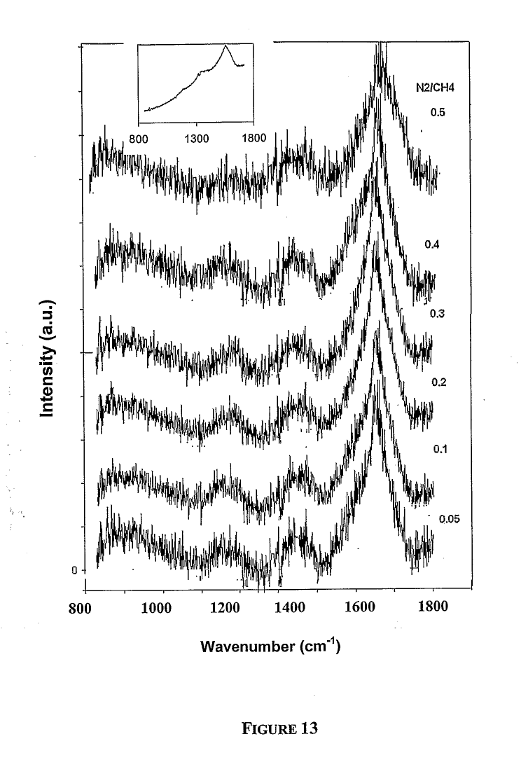

The micro-Raman spectra for each of the nanostructured diamond films on Ti-6Al-4V alloy are shown in FIG. 13. The diamond band at 1332 cm⁻¹ is significantly broadened, and Raman scattering intensity in the 1400-1600 cm¹ region is pronounced. This band is usually associated with the “G-band” of disordered graphite which is downshifted from 1580 cm⁻¹ and therefore likely involves scattering from amorphous sp² and sp³ bonded carbon domains. [M. A. Tamor and W. C. Vassell J. Appl. Phys. 76, 3823 (1994).] The Raman spectra have another peak at 1150 cm⁻¹ in addition to the main diamond and graphite bands. Without wishing to be bound by theory, it is believed that this band is due to the nanocrystalline nature of the diamond films. [J. Nemanich, J. T. Glass, G. Lucovsky, and R. E. Shroder, J. Vac. Sci. Technol. A 6, 1783 (1988).] The films produced consist of diamond nanocrystallites imbedded in amorphous carbon matrix with a relatively small amount of graphitic carbon.

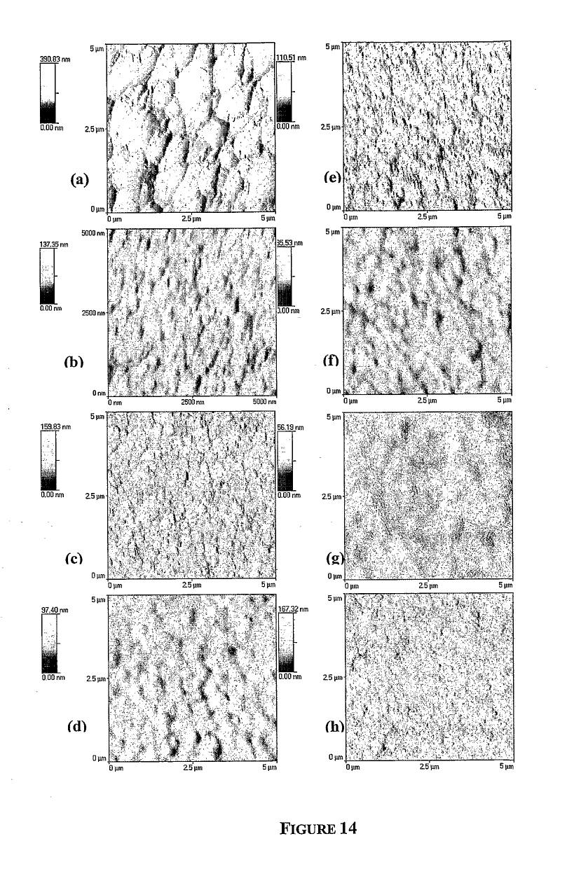

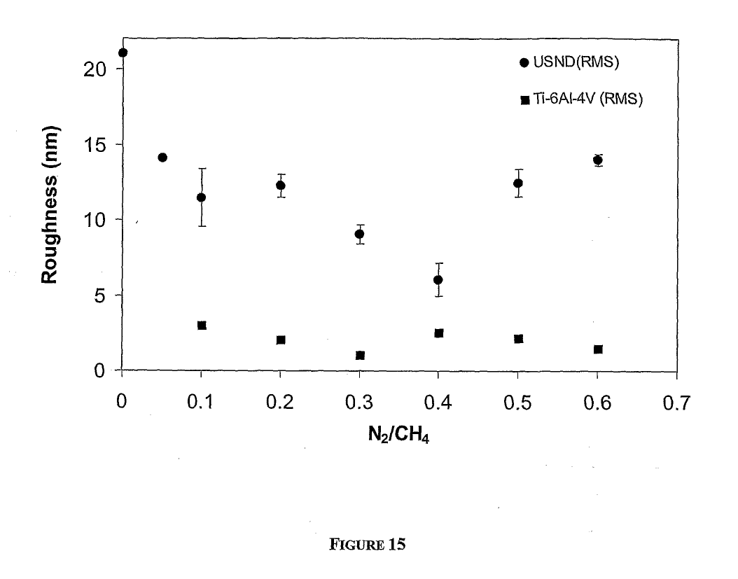

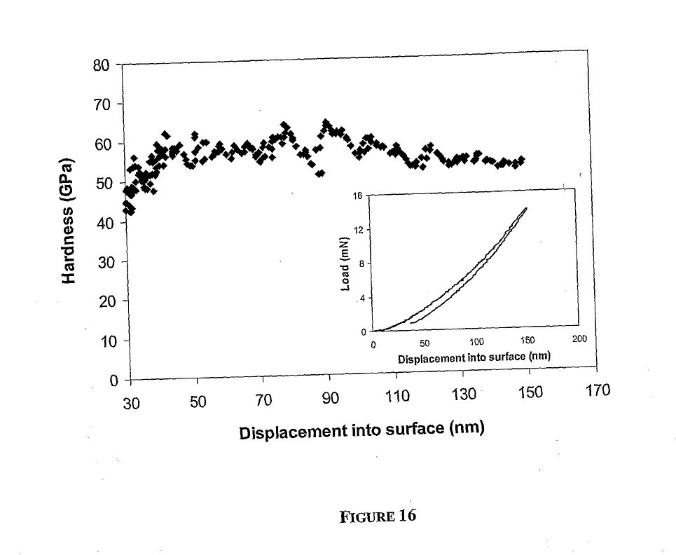

The plan view AFM images in FIG. 14 of the as-grown diamond films show the morphological change due to change in different deposition conditions. Roughness measurement by AFM in 2×2 μm² scan area for diamond films deposited in CH₄/H₂ plasma without N₂ (FIG. 14-a) and with N₂ addition (FIG. 14-b) was found to be 41 nm and 17 nm respectively. The AFM images of diamond films with different N₂/CH₄ ratios in He/H₂/CH₄/N₂ plasma are shown in FIG. 14 (c-h). The morphological changes with change in the N₂ concentration in the feed gases were clearly observed. Earlier roughness measurement showed that by adding He in CH₄/H₂ feedgas (with no N₂) changed the roughness of the diamond films dramatically (shown in FIG. 6b). A 9-10 nm RMS roughness value from diamond films deposited in He/H₂/CH₄/N₂ with 71% He in He+H₂ and N₂/CH₄ ratio of 0.1 was also reported [V. V Konovalov, A. Melo, S. A Catledge, S. Chowdhury, Y. K. Vohra, J. Nanosci. Nanotechnol., 6, 258 (2006).]. By increasing N₂/CH₄ ratio up to 0.4 in the same gas mixture roughness decreased even further to 6 nm (RMS) and produced ultra smooth diamond surfaces. These roughness values increased again with the increase of N₂/CH₄ ratios as shown in FIG. 15. The nanoindentation load-displacement curve and hardness values for N₂/CH₄ ratio of 0.4 are given in FIG. 16. Nanoindentation measurement revealed that the hardness (H) and modulus (E) of diamond films with different N₂/CH₄ ratios were in the range of H=50-60 GPa and E=330-380 GPa respectively.

Without wishing to be bound by theory, it is believed that the effect of He addition is not a simple effect of plasma dilution, but is based on a more complex mechanism. Diamond films grown in H₂/CH₄/N₂ plasma without He at corresponding high CH₄/H₂ ratio of 0.6 produced poor quality films with high content of graphitic phase. [S. A. Catledge and Y. K. Vohra: Effect of Nitrogen Feedgas Addition on the Mechanical Properties of Nano-Structured Carbon Coatings, in Mechanical Properties of Structural Films, eds. C. L. Muhlstein and S. T. Brown (ASTM STP1413, West Conshohocken, Pa., 2001).] Helium addition reduced the diamond grain size and this indicates that the rate of secondary nucleation/renucleation increases in He/H₂/CH₄/N₂ plasma, terminating the growth of large diamond nanocrystals. [V. V Konovalov, A. Melo, S. A Catledge, S. Chowdhury, Y. K. Vohra, J. Nanosci. Nanotechnol., 6; 258 (2006).] Again, without wishing to be bound by theory, it is believed that the effect of He addition was simply to increase the effective CH₄/H₂ ratio in He/H₂/CH₄/N₂ plasma, which should reduce the effect of hydrogen on suppressing secondary nucleation by regasifying nondiamond carbon. Helium has also a strong influence on the CN radical, which is known to increase the degree of diamond nanocrystallinity. [S. A. Catledge, J. Borham, Y. K. Vohra, W. R. Lacefield, and J. E. Lemons, J. Appl. Phys. 91, 5347 (2002); A. Afzal, C. A. Rego, W. Ahmed, and R. I. Cherry; Diam. Rel. Mater. 7, 1033 (1998); R. B. Corvin, J. G. Harrison, S. A. Catledge, and Y. K. Vohra, Appl. Phys. Lett. 84, 2550 (2002).] Small amounts of CN radicals in conventional CH₄/H₂ mixtures effectively abstract adsorbed H atoms, creating vacant growth sites and thereby reducing the carbon supersaturation. [S. Jin and T. D. Moustakas, Appl. Phys. Lett. 65, 403 (1994); G. Z. Cao, J. J. Schermer, W. J. P. van Enckevort, W. A. L. M. Elst, and L. J. Giling, J. Appl. Phys. 879, 1357 (1996); S. Bohr, R. Haubner, and B. Lux, Appl. Phys. Lett. 68, 1075 (1996).] The use of large N₂ additions (N₂/CH₄ ratios greater than 0.05) resulted in a reduction of diamond phase purity, a more nanocrystalline structure, and a smoother film surface. Therefore, higher CN species concentration can promote higher nanocrystallinity, and more CN species form in N₂ and He gas mixture. Higher CN levels also induced increased twinning and stacking faults resulting in the nanocrystalline structure. [A. Afzal, C. A. Rego, W. Ahmed, and R. I. Cherry, Diam. Rel. Mater. 7, 1033 (1998).] The larger amounts of CN resulted in excessive abstraction of adsorbed H, which leaves the surface open to further adsorption by CN or other nitrogen species that are not able to stabilize the diamond structure efficiently. [S. Bohr, R. Haubner, and B. Lux, Appl. Phys. Lett. 68, 1075 (1996).] Apart from causing the nanocrystallinity of the diamond component in the film, the addition of high amounts of nitrogen into the gas phase also resulted in higher amorphous carbon content in the film with a corresponding increase in the Raman 1550 cm⁻¹ peak intensity. [S. A. Catledge and Y. K. Vohra, J. Appl. Phys. 86, 698 (1999).] OES measurements taken from He/He/CH₄/N₂ plasma reflected that at 71% He content and N₂/CH₄ ratio of 0.1, both the CN/H_{α} and C₂/H_{α} were maximized. The present results indicated that at the same 71% He content and 0.4 N₂/CH₄ gas flow ratio there has been 2.5 times increase of CN/H_{α} ratio. There was no significant change in C₂/H_{α} values. The lowest roughness and smaller grain size values were achieved in the diamond films at the N₂/CH₄ ratio of 0.4. Thus, CN can influence formation of smooth nanocrystalline diamond films, and the activity of CN radical can be affected by the addition of He.

### C. CONCLUSION

Ultra smooth nanostructured diamond films were synthesized on Ti-6Al-4V medical grade substrates by adding helium in H₂/CH₄/N₂ plasma and by changing the N₂/CH₄ gas flow from 0 to 0.6. Diamond films with 6 nm (RMS) roughness in 2 μm² area and grain size 4-5 nm were deposited. Roughness decreased from RMS 22 nm to 6 nm from N₂/CH₄ ratio of 0.05 to 0.4 (CH₄ is fixed) and then increased again up to 13 nm at N₂/CH₄ ratio of 0.6. Raman spectra were typical for nanostructured diamond films and did not show significant changes with varying N₂/CH₄ ratio. Nanoindentation demonstrated that the hardness and Young's modulus of the films are in the range of 50-60 GPa and 330-380 GPa, respectively. XRD showed that all the spectra have broad diamond (111) peaks characteristic of nanostructure diamond and the grain size was calculated between 4-8 nm. The grain size decreased and drop to around 4-5 nm as the N₂/CH₄ ratio increased up to 0.4, and then again increased. The surface morphology imaged by nano SEM at 300,000× also confirms the nanocrystallinity of the diamond films. It was also found that, as the N₂ content increased, the intensity of the TiC peak decreased. At a N₂/CH₄ ratio of 0.4 there was no (200) TiC peak and the intensity again increased as the N₂/CH₄ ratio increased beyond 0.4. Without wishing to be bound by theory, it is believed that reducing diamond grain size and film surface roughness by He addition can be attributed to plasma dilution, enhanced fragmentation of carbon containing species, and enhanced formation of CN radical. From optical emission data we found that CN/H_{α} relative intensity was highest at a N₂/CH₄ gas concentration ratio of 0.4, which resulted in the smoothest nanostructured hard diamond films. Therefore, it can be concluded that CN radical has an influence in formation of smooth nanocrystalline diamond films.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of producing an ultra smooth nanostructured diamond film on a surface comprising the steps of:
a. providing a mixture comprising a noble gas, hydrogen, a carbon precursor, and nitrogen, wherein the noble gas and the nitrogen are present in combined concentration of less than about 80 vol % of the mixture;
b. establishing a plasma comprising the mixture; and
c. depositing carbon-containing species from the plasma onto the surface, thereby producing a film on the surface.

2. (canceled)

3. The method of claim 1, wherein the carbon precursor is present in a concentration of at least about 4 vol % of the mixture.

4-6. (canceled)

7. The method of claim 1, wherein the noble gas component comprises helium.

8-11. (canceled)

12. The method of claim 1, wherein the surface comprises at least one of zirconium, titanium, aluminum, molybdenum, vanadium, niobium, cobalt, chrome, silicon, silicon oxide, aluminum oxide, zirconium oxide, or titanium oxide, or a mixture thereof, an alloy thereof, or a composite thereof.

13-16. (canceled)

17. The method of claim 1, wherein the surface comprises at least one of Ti-6Al-4V, Ti-13Nb-13Zr, CoCr, CoCrMo, or steel, or a mixture thereof, or a composite thereof.

18-21. (canceled)

22. A composition comprising:
a. a noble gas component,
b. hydrogen,
c. a carbon precursor, and
d. nitrogen,
wherein the noble gas component and the nitrogen are present in a combined concentration of less than about 80 vol % of the composition.

23. (canceled)

24. The composition of claim 22, wherein the carbon precursor is present in a concentration of at least about 4 vol % of the composition.

25-28. (canceled)

29. The composition of claim 22, wherein the nitrogen is present in a concentration of approximately one-tenth the concentration of the carbon precursor.

30-31. (canceled)

32. The composition of claim 22, wherein the noble gas component comprises helium.

33. The composition of claim 22, wherein the carbon precursor comprises methane, a C₂ to C₁₂ alkane, ethene, a C₃ to C₁₂ alkene, acetylene, a C₃ to C₁₂ alkyne, benzene, toluene, xylene, a C₁ to C₁₂ alcohol, graphitic particles, a carbon cluster of at least C₂, buckminsterfullerene, a higher fullerene, a carbon nanotube, a carbon nanoparticle, or a mixture thereof.

34. The composition of claim 22, wherein the carbon precursor comprises methane.

35-36. (canceled)

37. An ultra smooth nanostructured diamond film having an average grain size of from about 3 nm to about 9 nm and an RMS surface roughness of from about 5 nm to about 14 nm.

38. The film of claim 37, wherein the RMS surface roughness is from about 5 nm to about 10 nm, before polishing of the film.

39. (canceled)

40. The film of claim 37, having a relative diamond crystallinity of at least about 30%.

41-43. (canceled)

44. An ultra smooth nanostructured diamond film having an average grain size of from about 3 nm to about 8 nm and a relative diamond crystallinity of up to about 70%.

45. The film of claim 44, wherein the relative diamond crystallinity is from about 30% to about 70%.

46. The film of claim 44, wherein the relative diamond crystallinity is from about 40% to about 60%.

47. A carbon-based film having an RMS surface roughness of less than about 14 nm and a hardness of at least about 50 GPa.

48. The film of claim 47, wherein the RMS surface roughness is less than about 14 nm before polishing of the film.

49-51. (canceled)

52. The film of claim 47, wherein the hardness is at least about 60 GPa.

53-56. (canceled)
